(19) United States
(12) Patent Application Publication
(10) Pub. No.: US 2015/0344249 A1
(43) Pub. Date: Dec. 3, 2015

(54) PAPER TRANSPORTING DEVICE AND IMAGE FORMING DEVICE

(71) Applicant: FUJIFILM Corporation, Tokyo (JP)

(72) Inventors: Takahiro INOUE, Kanagawa (JP); Toshiya KOJIMA, Kanagawa (JP)

(73) Assignee: FUJIFILM CORPORATION, Tokyo (JP)

(21) Appl. No.: 14/825,896

(22) Filed: Aug. 13, 2015

Related U.S. Application Data
(63) Continuation of application No. PCT/JP2014/053046, filed on Feb. 10, 2014.

(30) Foreign Application Priority Data
Feb. 28, 2013 (JP) 2013-039048

(51) Int. Cl. B65H 5/08; B41J 11/00; B65H 43/00; B65H 37/00; B65H 5/02; B65H 9/00

(52) U.S. Cl. CPC B65H 5/08; B65H 5/021; B65H 9/00; B65H 43/00; B65H 37/00; B41J 11/002

(57) ABSTRACT

When a distal end of a paper is gripped by a gripper of a chain gripper and transported, the paper is transported while being in sliding contact with a guide surface of a guide plate. On the guide surface of the guide plate, a groove is formed along a traveling route of the gripper, and by a claw member entering the groove, a height of the distal end of the paper gripped by the gripper and a height of the guide surface are matched.

### CROSS-REFERENCE TO RELATED APPLICATIONS

This application is a Continuation of PCT International Application No. PCT/JP2014/053046 filed on Feb. 10, 2014, which claims priority under 35 U.S.C §119(a) to Japanese Patent Application No. 2013-039048 filed on Feb. 28, 2013. Each of the above applications is hereby expressly incorporated by reference, in their entirety, into the present application.

### BACKGROUND OF THE INVENTION

1. Field of the Invention

The present invention relates to a paper transporting device and an image forming device, and particularly relates to a paper transporting device that grips and transports a distal end of paper by a chain gripper and guides and transports the paper by a guide surface of a guide device.

2. Description of the Related Art

As an image forming device, an inkjet recorder that discharges droplets of ink (jets ink) from an inkjet head to a sheet of paper (paper sheet) and records a prescribed image on a recording surface of the paper sheet is known. Then, the inkjet recorder including a drying unit that executes a drying process of drying the paper to which the ink is jetted is known.

Conventionally, as a paper transporting device in the drying unit, the one using a chain gripper is known. The chain gripper is a paper transporting device that includes a plurality of grippers between a pair of chains which are circulated, grips a distal end of paper by the grippers, and transports it to a prescribed position.

Also, the paper transporting device using the chain gripper includes a guide device that provides a guide surface for controlling a posture during transportation of the paper whose distal end is gripped by the chain gripper.

In such a paper transporting device using the chain gripper, in National Publication of International Patent Application No. 11-501603 (PTL 1), a guide device that guides paper on an assumed read surface without bringing it into contact with a guide surface by generating an air stream between the paper whose distal end is gripped by a chain gripper and the guide surface is proposed.

Also, in Japanese Patent Application Laid-Open No. 6-211402 (PTL 2), a guide device that prevents generation of a relative speed between paper and a belt surface of an adsorption belt as a guide surface by sucking the paper whose distal end is gripped by a chain gripper by a suction belt and moving the suction belt at the same speed as a transporting speed of the paper is proposed.

Also, in Japanese Utility Model Laid-Open No. 1-176654 (PTL 3), a guide device provided with a plurality of air suction slits on a guide surface is proposed.

### SUMMARY OF THE INVENTION

Now, in the case of transporting paper by a chain gripper as described above in a drying process for drying printed paper to which ink has been jetted, it is desirable to execute processing of the drying process while guiding the paper whose distal end is gripped by grippers by a flat guide surface, in order to obtain a high-quality printed matter with no deformation such as a curl generated on the printed paper after the drying process.

However, since it is needed to prevent the grippers from being in contact with the guide surface, a clearance between the grippers and the guide surface is needed.

When there is such a clearance, since the distal end of the paper gripped by the grippers is transported in the state of being separated from the guide surface and the paper is dried in a warped state (deformed state), there is a risk that the paper is curled after being dried.

When the printed paper is curled, quality as a printed matter declines.

Also, in the case of performing back surface printing, there is a risk that wrinkles or floats are generated on a transporting surface by the curled paper. Thus, there is a risk that image quality declines. Also, in the case of an inkjet recorder, there is a risk that an inkjet head is damaged by floated paper.

In PTL 1 and PTL 3, a technology of giving an air stream between paper and a guide surface, floating the paper, and transporting the paper without bringing it into contact with the guide surface is disclosed. However, in order to keep the paper in parallel with a transporting direction by the technology, flow of the air stream needs to be controlled for each paper having different paper thickness, paper weight and rigidity, and there is a problem of technical difficulty. Also, PTL 1 and PTL 3 prevent offset and transportation scratches of a paper transporting surface and flapping of the paper, and do not intend to prevent deformation of the paper.

In PTL 2, while a technology of preventing transportation scratches by belt transportation of paper is disclosed, there is a clearance between grippers and a belt surface which is a guide surface, and the above-described problem is not solved.

The present invention is implemented in consideration of such circumstances, and an object is to provide a paper transporting device and an image forming device capable of transporting paper while keeping the entire paper in a flat shape including a distal end of the paper gripped by paper gripping means (gripper).

In order to achieve the object, the paper transporting device according to one mode of the present invention includes a paper gripping unit that grips a distal end of paper turning the paper to an upstream side of a transporting direction of transporting the paper by a plurality of claw parts arranged side by side in a width direction orthogonal to the transporting direction, a transporting unit that moves the paper gripping unit to a downstream side of the transporting direction and transports the paper gripped by the paper gripping unit to the downstream side of the transporting direction, and a paper guide unit including a guide surface arranged along a plane in parallel with the transporting direction and the width direction, that is the guide surface to which one surface of the paper gripped by the paper gripping unit is brought into contact, the paper guide unit has a recess recessed to the guide surface, which is the recess that a part of each of the plurality of claw parts of the paper gripping unit enters, and the guide surface is arranged at a position corresponding to a position where the claw parts grip the paper regarding a direction orthogonal to the transporting direction and the width direction.

According to the present invention, when gripping the distal end of the paper by the claw parts like a chain gripper, bringing the paper into contact with the guide surface which is a plane and transporting it, a position (the position in the direction orthogonal to the paper transporting direction and the width direction: it is a height, here) of the distal end of the paper gripped by the claw parts by making the claw parts enter the recess formed to the guide surface can be matched with a height corresponding to a height of the guide surface. Therefore, the entire paper can be transported while being kept in a flat shape including the distal end of the paper, and deformation such as a warp is not generated on the paper after being transported.

In the paper transporting device according to another mode of the present invention, the paper guide unit includes the guide surface formed on a fixing member, and has a groove extending along a route in the transporting direction where the claw parts are moved by the transporting unit, as the recess.

In the case that the guide surface is formed on the fixing member as in this mode, by forming the groove along the route where the claw parts gripping the paper are moved and making the claw parts enter the groove, the height of the distal end of the paper gripped by the claw parts can be matched with the height of the guide surface.

In the paper transporting device according to still another mode of the present invention, the paper guide unit can be in the mode of having the groove corresponding to each of the plurality of claw parts. In the case of having the groove corresponding to each of the plurality of claw parts as in this mode, an area of the guide surface can be increased, and bending or the like of the paper by the groove can be suppressed.

In the paper transporting device according to still another mode of the present invention, the paper guide unit can be in the mode of including the guide surface formed on a belt surface of an endless belt circulated at the same speed as a transporting speed of the paper, and having a groove along the width direction that all the claw parts of the plurality of claw parts arranged side by side in the width direction enter, as the recess.

In the case that the guide surface is formed on the belt surface of the belt circulated at the same speed as the transporting speed of the paper as in this mode, since relative positions of the paper and the guide surface do not change, all the claw parts arranged side by side in the width direction can be made to enter one groove along the width direction. In the case of this mode, since the need of a groove extending in the transporting direction is eliminated, there is no groove (recess) at parts other than the distal end of the paper, and bending of the paper by the groove can be prevented.

In the paper transporting device according to still another mode of the present invention, the paper guide unit is a unit that forms the guide surface on a belt surface of an endless belt circulated at the same speed as a transporting speed of the paper, and has recesses corresponding to each of the plurality of claw parts arranged side by side in the width direction, as the recess.

As in this mode, in the case that the guide surface is formed on the belt surface of the belt circulated at the same speed as the transporting speed of the paper, all the claw parts arranged side by side in the width direction can be made to enter the corresponding recesses respectively without making them enter one groove along the width direction.

In the paper transporting device according to still another mode of the present invention, the paper guide unit can be in the mode of including an adsorption unit that adsorbs the paper to the guide surface.

By adsorbing the paper to the guide surface as in this mode, flapping of the paper during transportation can be prevented.

As the adsorption unit, a unit that adsorbs the paper by sucking air from an adsorption hole formed on the guide surface or a unit that adsorbs the paper by electrostatic adsorption can be used.

In the paper transporting device according to still another mode of the present invention, it is desirable that the paper guide unit is in the mode of arranging the guide surface at a position that coincides with a position where the claw parts grip the paper regarding a direction orthogonal to the transporting direction and the width direction.

By a configuration as in this mode, the height of the distal end of the paper and the height of the guide surface can be accurately matched.

Also, in order to achieve the object, the image forming device according to one mode of the present invention includes an image forming unit that forms images on paper, a drying unit that dries the paper where the images are formed by the image forming unit, and the paper transporting device that transports the paper where the images are formed by the image forming unit, which is the paper transporting device provided with the drying unit in a transporting route of the paper.

According to the present invention, when gripping the distal end of the paper by the claw parts like a chain gripper, bringing the paper into contact with the guide surface which is a plane and transporting it, the height of the distal end of the paper gripped by the claw parts by making the claw parts enter the recess formed to the guide surface can be matched with the height corresponding to the height of the guide surface. Therefore, the entire paper can be transported while being kept in a flat shape including the distal end of the paper, and deformation such as a warp is not generated on the paper after being transported. Particularly, when the paper after the images are formed is dried in a state that the paper is warped, the paper is curled, and there is a risk of inviting decline of quality. According to the present invention, such a situation can be prevented.

According to the present invention, the entire paper can be transported while being kept in a flat shape including the distal end of the paper gripped by the paper gripping means (gripper).

### BRIEF DESCRIPTION OF THE DRAWINGS

FIG. 1 is an overall block diagram of an inkjet recorder;

FIG. 2 is a block diagram of a control system of the inkjet recorder;

FIG. 3 is a side view illustrating a schematic configuration of a paper transporting mechanism by a chain gripper;

FIG. 4 is a front view illustrating a configuration example of a gripper;

FIG. 5 is a plan view illustrating a configuration example of the gripper;

FIG. 6 is a sectional view on arrows 6-6 in FIG. 4;

FIG. 7A is a diagram illustrating an operation of the gripper;

FIG. 7B is a diagram illustrating the operation of the gripper;

FIG. 8 is a plan view of a guide plate of a guide part in a first embodiment;

FIG. 9 is a sectional view on arrows 9-9 in FIG. 8;

FIG. 10 is an enlarged view of a main section of FIG. 9;

FIG. 11 is a plan view illustrating a modification of a guide plate in the first embodiment;

FIG. 12 is a plan view of a guide plate of a guide part in a second embodiment;

FIG. 13 is a sectional view on arrows 13-13 in FIG. 12;

FIG. 14 is a side view illustrating a configuration of a guide part in a third embodiment;

FIG. 15 is a plan view illustrating an adsorption belt of a guide part in the third embodiment;

FIG. 16 is a sectional view on 16-16 in FIG. 15; and

FIG. 17 is a plan view illustrating a modification of an adsorption belt of a guide part in the third embodiment.

### DETAILED DESCRIPTION OF EXEMPLARY EMBODIMENTS

Hereinafter, preferable embodiments of the present invention will be described in detail according to the attached drawings.

### First Embodiment

### Device Configuration

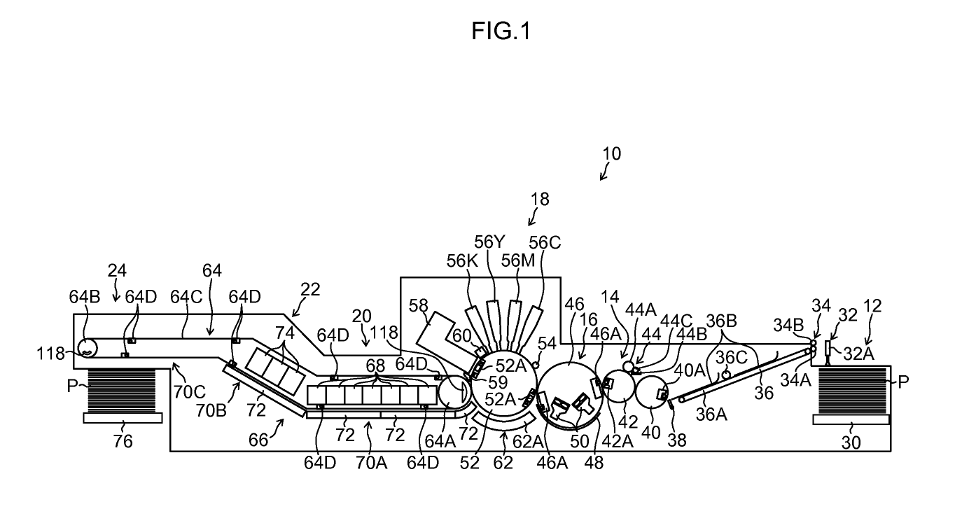

FIG. 1 is an overall block diagram illustrating one embodiment of an inkjet recorder to which the present invention is applied.

This inkjet recorder 10 is a sheet-type aqueous UV inkjet printer that records images on paper (sheet paper) P by an inkjet method using aqueous UV ink (UV (ultraviolet ray) curing type aqueous ink (ink for which a coloring material such as dye or pigment is dissolved or dispersed in water or water-soluble solvent)). The inkjet recorder 10 includes a paper feeding part 12 that feeds the paper P, a process liquid imparting part 14 that imparts a prescribed process liquid to a surface (image recording surface) of the paper P fed from the paper feeding part 12, a process liquid drying processing part 16 that performs drying processing of the paper P to which the process liquid is imparted in the process liquid imparting part 14, an image recording part 18 that records images by the inkjet method using the aqueous UV ink on the surface of the paper P to which the drying processing is executed in the process liquid drying processing part 16, an ink drying processing part 20 that performs the drying processing of the paper P on which the images are recorded in the image recording part 18, a UV irradiation processing part 22 that fixes the images by performing UV irradiation processing to the paper P to which the drying processing is performed in the ink drying processing part 20, and a paper discharge part 24 that discharges the paper P to which the UV irradiation processing is performed in the UV irradiation processing part 22.

### Paper Feeding Part

The paper feeding part 12 feeds the paper P loaded on a paper feeding base 30 sheet by sheet to the process liquid imparting part 14. The paper feeding part 12 mainly includes the paper feeding base 30, a sucker device 32, a paper feeding roller pair 34, a feeder board 36, a front contact 38, and a paper feeding drum 40.

The paper P is mounted on the paper feeding base 30 in the state of a bundle for which many sheets are stacked. The paper feeding base 30 is provided so as to be elevated and lowered by a paper feeding base elevating and lowering device which is not illustrated. The drive of the paper feeding base elevating and lowering device is controlled in linkage with increase/decrease of the paper P loaded on the paper feeding base 30 to elevate and lower the paper feeding base 30 so that the paper P positioned at the top of the bundle is positioned at a fixed height at all times.

The paper P is not limited in particular, and general purpose printing paper (the paper mainly composed of cellulose such as so-called pure paper, coated paper or art paper) used in general offset printing or the like can be used. In this case, coating paper is used. The coating paper is the one provided with a coating layer by applying a coating material on a surface of pure paper or neutral paper or the like whose surface is not treated generally. Specifically, art paper, coated paper, light-weight coated paper, fine coating paper or the like is suitably used.

The sucker device 32 takes up the paper P loaded on the paper feeding base 30 sheet by sheet in order from the top, and feeds it to the paper feeding roller pair 34. The sucker device 32 includes a suction foot 32A provided so as to be freely elevated and lowered and freely swung, adsorbs and holds an upper surface of the paper P by the suction foot 32A, and transfers the paper P from the paper feeding base 30 to the paper feeding roller pair 34. At the time, the suction foot 32A adsorbs and holds the upper surface on a distal end side of the paper P positioned at the top of the bundle, pulls up the paper P, and inserts the distal end of the pulled-up paper P between a pair of rollers 34A and 34B configuring the paper feeding roller pair 34.

The paper feeding roller pair 34 is constituted of the pair of upper and lower rollers 34A and 34B pressurized and brought into contact with each other. For the pair of upper and lower rollers 34A and 34B, one is a driving roller (roller 34A), the other is a driven roller (roller 34B), and the driving roller (roller 34A) is driven and rotated by a motor which is not illustrated. The motor is driven in linkage with feed of the paper P, and when the paper P is fed from the sucker device 32, the driving roller (roller 34A) is rotated at the timing. The paper P inserted between the pair of upper and lower rollers 34A and 34B is nipped by the rollers 34A and 34B, and sent out in a rotating direction (an installation direction of the feeder board 36) of the rollers 34A and 34B.

The feeder board 36 is formed corresponding to a paper width, receives the paper P sent out from the paper feeding roller pair 34, and guides it to the front contact 38. The feeder board 36 is installed with the distal end side inclined downwards, slides the paper P mounted on a transporting surface thereof along the transporting surface, and guides it to the front contact 38.

To the feeder board 36, a plurality of tape feeders 36A for transporting the paper P along the transporting surface are installed at intervals in the width direction. The tape feeders 36A are formed in an endless shape, and driven and rotated by a motor which is not illustrated. The paper P mounted on the transporting surface of the feeder board 36 is supplied with feed force by the tape feeders 36A, and is transported on the feeder board 36.

Also, on the feeder board 36, a retainer 36B and a roller 36C are installed.

The plurality (two in this case) of retainers 36B are arranged in a column at the front and back along the transporting surface of the paper P. The retainer 36B is constituted of a leaf spring having a width corresponding to the paper width, and is installed while being pressurized and brought into contact with the transporting surface. For the paper P transported on the feeder board 36 by the tape feeders 36A, ruggedness is corrected by passing through the retainers 36B. Also, for the retainer 36B, in order to easily introduce the paper P between the retainer 36B and the feeder board 36, a rear end is curled and formed.

The roller 36C is disposed between the front and back retainers 36B. The roller 36C is installed while being pressurized and brought into contact with the transporting surface of the paper P. The paper P transported between the front and back retainers 36B is transported while the upper surface is pressed by the roller 36C.

The front contact 38 corrects a posture of the paper P. The front contact 38 is formed in a plate shape, and is arranged orthogonally to the transporting direction of the paper P. Also, the front contact 38 is driven by a motor which is not illustrated, and is provided so as to be swung. For the paper P transported on the feeder board 36, the distal end thereof is brought into contact with the front contact 38, and the posture is corrected (so-called skew prevention). The front contact 38 is swung in linkage with the feed of the paper to the paper feeding drum 40, and delivers the paper P whose posture is corrected to the paper feeding drum 40.

The paper feeding drum 40 receives the paper P fed from the feeder board 36 through the front contact 38, and transports it to the process liquid imparting part 14. The paper feeding drum 40 is formed in a cylindrical shape, and driven and rotated by a motor which is not illustrated. A gripper 40A is provided on an outer peripheral surface of the paper feeding drum 40, and the distal end of the paper P is gripped by the gripper 40A. By gripping the distal end of the paper P by the gripper 40A and being rotated, the paper feeding drum 40 transports the paper P to the process liquid imparting part 14 while winding the paper P around a peripheral surface.

The paper feeding part 12 is configured as above. The paper P loaded on the paper feeding base 30 is pulled up sheet by sheet in order from the top by the sucker device 32, and fed to the paper feeding roller pair 34. The paper P fed to the paper feeding roller pair 34 is sent out to the front by the pair of upper and lower rollers 34A and 34B configuring the paper feeding roller pair 34, and mounted on the feeder board 36. The paper P mounted on the feeder board 36 is transported by the tape feeders 36A provided on the transporting surface of the feeder board 36. Then, in the transportation process, the paper P is pressed to the transporting surface of the feeder board 36 by the retainers 36B, ruggedness is corrected. For the paper P transported by the feeder board 36, inclination is corrected by bringing the distal end into contact with the front contact 38, and the paper P is delivered to the paper feeding drum 40. Then, it is transported to the process liquid imparting part 14 by the paper feeding drum 40.

### Process Liquid Imparting Part

The process liquid imparting part 14 imparts the prescribed process liquid to the surface (image recording surface) of the paper P. The process liquid imparting part 14 mainly includes a process liquid imparting drum 42 that transports the paper P, and a process liquid imparting unit 44 that imparts the prescribed process liquid to a printing surface of the paper P transported by the process liquid imparting drum 42.

The process liquid imparting drum 42 receives the paper P from the paper feeding drum 40 of the paper feeding part 12, and transports the paper P to the process liquid drying processing part 16. The process liquid imparting drum 42 is formed in a cylindrical shape, and driven and rotated by a motor which is not illustrated. A gripper 42A is provided on an outer peripheral surface of the process liquid imparting drum 42, and the distal end of the paper P is gripped by the gripper 42A. By gripping the distal end of the paper P by the gripper 42A and being rotated, the process liquid imparting drum 42 transports the paper P to the process liquid drying processing part 16 while winding the paper P around a peripheral surface (transports a sheet of the paper P by one rotation). Regarding the process liquid imparting drum 42 and the paper feeding drum 40, the rotation thereof is controlled so as to match the timings of receiving and delivering the paper P of each other. That is, drive is performed so as to be the same peripheral speed, and the drive is performed so as to match the positions of the grippers of each other.

The process liquid imparting unit 44 applies the process liquid to the surface of the paper P transported by the process liquid imparting drum 42 by a roller. The process liquid imparting unit 44 mainly includes a coating roller 44A that applies the process liquid to the paper P, a process liquid tank 44B where the process liquid is stored, and a drawing roller 44C that draws the process liquid stored in the process liquid tank 44B and supplies it to the coating roller 44A. The drawing roller 44C is installed while being pressurized and brought into contact with the coating roller 44A, and is installed while being partially immersed in the process liquid stored in the process liquid tank 44B. The drawing roller 44C measures and draws the process liquid and imparts the process liquid by a fixed thickness to the peripheral surface of the coating roller 44A. The coating roller 44A is provided corresponding to the paper width, is pressurized and brought into contact with the paper P, and applies the process liquid imparted to the peripheral surface to the paper P. The coating roller 44A is driven by a contact and separation mechanism which is not illustrated, and is moved between a contact position to be in contact with the peripheral surface of the process liquid imparting drum 42 and a separation position to be separated from the peripheral surface of the process liquid imparting drum 42. The contact and separation mechanism moves the coating roller 44A matched with a passing timing of the paper P to apply the process liquid to the surface of the paper P transported by the process liquid imparting drum 42.

Also, while a configuration is such that the process liquid is applied by a roller in this case, a method of imparting the process liquid is not limited thereto. In addition, a configuration of imparting it using an inkjet head or a configuration of imparting it by a spray can be adopted.

The process liquid imparting part 14 is configured as above. The paper P delivered from the paper feeding drum 40 of the paper feeding part 12 is received by the process liquid imparting drum 42. The process liquid imparting drum 42 winds the paper P around the peripheral surface and transports it by gripping the distal end of the paper P by the gripper 42A and being rotated. In the transportation process, the coating roller 44A is pressurized and brought into contact with the surface of the paper P, and the process liquid is applied to the surface of the paper P.

Here, for the process liquid to be applied to the surface of the paper P, the process liquid having a function of aggregating the coloring material in the aqueous UV ink to be jetted to the paper P in the image recording part 18 of a subsequent stage is applied. By applying such a process liquid to the surface of the paper P and jetting the aqueous UV ink, even in the case of using the general purpose printing paper, high-quality printing can be performed without causing impact interference or the like.

### Process Liquid Drying Processing Part

The process liquid drying processing part 16 performs the drying processing to the paper P for which the process liquid is imparted to the surface. The process liquid drying processing part 16 mainly includes a process liquid drying processing drum 46 that transports the paper P, a paper transporting guide 48, and a process liquid drying processing unit 50 that performs drying by blowing hot air to the printing surface of the paper P transported by the process liquid drying processing drum 46.

The process liquid drying processing drum 46 receives the paper P from the process liquid imparting drum 42 of the process liquid imparting part 14, and transports the paper P to the image recording part 18. The process liquid drying processing drum 46 is constituted of a frame body assembled in a cylindrical shape, and is driven and rotated by a motor which is not illustrated. A gripper 46A is provided on an outer peripheral surface of the process liquid drying processing drum 46, and the distal end of the paper P is gripped by the gripper 46A. By gripping the distal end of the paper P by the gripper 46A and being rotated, the process liquid drying processing drum 46 transports the paper P to the image recording part 18. Also, the process liquid drying processing drum 46 of this case is configured such that the gripper 46A is disposed at two parts on the outer peripheral surface and two sheets of paper P can be transported by one rotation. For the process liquid drying processing drum 46 and the process liquid imparting drum 42, the rotation is controlled so as to match the timings of receiving and delivering the paper P of each other. That is, the drive is performed so as to be the same peripheral speed, and the drive is performed so as to match the positions of the grippers of each other.

The paper transporting guide 48 is disposed along a transporting route of the paper P by the process liquid drying processing drum 46, and guides the transportation of the paper P.

The process liquid drying processing unit 50 is installed on an inner side of the process liquid drying processing drum 46, and performs the drying processing by blowing the hot air to the surface of the paper P transported by the process liquid drying processing drum 46. In this case, the two process liquid drying processing units 50 are disposed inside the process liquid drying processing drum, and configured to blow the hot air to the surface of the paper P transported by the process liquid drying processing drum 46.

The process liquid drying processing part 16 is configured as above. The paper P delivered from the process liquid imparting drum 42 of the process liquid imparting part 14 is received by the process liquid drying processing drum 46. The process liquid drying processing drum 46 transports the paper P by gripping the distal end of the paper P by the gripper 46A and being rotated. At the time, the process liquid drying processing drum 46 performs the transportation with the surface (the surface where the process liquid is applied) of the paper P turned to the inner side. The hot air is blown to the surface from the process liquid drying processing unit 50 installed on the inner side of the process liquid drying processing drum 46 and the drying processing is executed to the paper P in the process of being transported by the process liquid drying processing drum 46. That is, a solvent component in the process liquid is removed. Thus, an ink aggregation layer is formed on the surface (image recording surface) of the paper P.

### Image Recording Part

The image recording part 18 draws a color image on the printing surface of the paper P by jetting droplets of the ink (aqueous UV ink) of individual colors of C (cyan), M (magenta), Y (yellow) and K (black) to the printing surface of the paper P. The image recording part 18 mainly includes an image recording drum 52 that transports the paper P, a paper pressing roller 54 that pressurizes the paper P transported by the image recording drum 52 and closely attaches the paper P to a peripheral surface of the image recording drum 52, inkjet heads 56C, 56M, 56Y and 56K that discharge the ink droplets of the individual colors of C, M, Y and K to the paper P, an inline sensor 58 that reads the image recorded on the paper P, a mist filter 60 that captures ink mist, and a drum temperature control unit 62.

The image recording drum 52 receives the paper P from the process liquid drying processing drum 46 of the process liquid drying processing part 16 and transports the paper P to the ink drying processing part 20. The image recording drum 52 is formed in a cylindrical shape, and driven and rotated by a motor which is not illustrated. A gripper 52A is provided on an outer peripheral surface of the image recording drum 52, and the distal end of the paper P is gripped by the gripper 52A. By gripping the distal end of the paper P by the gripper 52A and being rotated, the image recording drum 52 transports the paper P to the ink drying processing part 20 while winding the paper P around a peripheral surface. Also, on the peripheral surface of the image recording drum 52, many adsorption holes (not illustrated) are formed in a prescribed pattern. The paper P wound around the peripheral surface of the image recording drum 52 is transported while being adsorbed and held on the peripheral surface of the image recording drum 52 by being sucked from the adsorption holes. Thus, the paper P can be transported with high smoothness.

Also, suction from the adsorption hole acts only in a fixed range, and acts only between a prescribed suction start position and a prescribed suction end position. The suction start position is set at an installation position of the paper pressing roller 54, and the suction end position is set on a downstream side of the installation position of the inline sensor 58 (for example, set at a position of delivering the paper to the ink drying processing part 20). That is, an adsorption area is set so that the paper P is adsorbed and held on the peripheral surface of the image recording drum 52 at least at an ink jetting position by the respective inkjet heads 56C, 56M, 56Y and 56K and an image reading position by the inline sensor 58.

Also, a mechanism of adsorbing and holding the paper P on the peripheral surface of the image recording drum 52 is not limited to an adsorption method by a negative pressure described above, and a method by electrostatic adsorption can be also adopted.

Also, the image recording drum 52 of this case is configured such that the gripper 52A is disposed at two parts on the outer peripheral surface and two sheets of paper P can be transported by one rotation. For the image recording drum 52 and the process liquid drying processing drum 46, the rotation is controlled so as to match the timings of receiving and delivering the paper P of each other. That is, the drive is performed so as to be the same peripheral speed, and the drive is performed so as to match the positions of the grippers of each other.

The paper pressing roller 54 is disposed near a paper receiving position (a position of receiving the paper P from the process liquid drying processing drum 46) of the image recording drum 52. The paper pressing roller 54 is constituted of a rubber roller, and is installed while being pressurized and brought into contact with the peripheral surface of the image recording drum 52. The paper P delivered from the process liquid drying processing drum 46 to the image recording drum 52 is nipped by passing through the paper pressing roller 54, and is closely attached to the peripheral surface of the image recording drum 52.

The four inkjet heads 56C, 56M, 56Y and 56K are arranged at fixed intervals along the transporting route of the paper P by the image recording drum 52. The inkjet heads 56C, 56M, 56Y and 56K are constituted of a line head corresponding to the paper width. The individual inkjet heads 56C, 56M, 56Y and 56K are arranged orthogonally to the transporting direction of the paper P by the image recording drum 52, and are arranged such that the nozzle surface thereof faces the peripheral surface of the image recording drum 52. The individual inkjet heads 56C, 56M, 56Y and 56K record the image on the paper P transported by the image recording drum 52 by discharging the droplets of the ink from a nozzle column formed on the nozzle surface toward the image recording drum 52.

Also, for the ink to be discharged from the individual inkjet heads 56C, 56M, 56Y and 56K as described above, the aqueous UV ink is used. The aqueous UV ink can be cured by being irradiated with ultraviolet rays (UV) after being jetted.

The inline sensor 58 is installed on the downstream side of the inkjet head 56K positioned at the end with respect to the transporting direction of the paper P by the image recording drum 52, and reads the images recorded by the inkjet heads 56C, 56M, 56Y and 56K. The inline sensor 58 is constituted of a line scanner for example, and reads the images recorded by the inkjet heads 56C, 56M, 56Y and 56K from the paper P transported by the image recording drum 52.

Also, on the downstream side of the inline sensor 58, a contact preventing plate 59 is installed closely to the inline sensor 58. The contact preventing plate 59 prevents the paper P from being in contact with the inline sensor 58 in the case that the paper P is floated due to a failure of transportation or the like.

The mist filter 60 is disposed between the inkjet head 56K at the end and the inline sensor 58, sucks the air around the image recording drum 52, and captures the ink mist. By capturing the ink mist by sucking the air around the image recording drum 52, entry of the ink mist to the inline sensor 58 can be prevented. Thus, occurrence of a read defect or the like can be prevented.

The drum temperature control unit 62 blows air conditioning air to the image recording drum 52, and controls a temperature of the image recording drum 52. The drum temperature control unit 62 mainly includes an air conditioner (air conditioner, not illustrated), and a duct 62A configured to blow the air conditioning air supplied from the air conditioner to the peripheral surface of the image recording drum 52. The duct 62A is configured to control the temperature of the image recording drum 52 by blowing the air conditioning air in an area other than a transporting area of the paper P to the image recording drum 52. In this case, since the paper P is transported along an arc surface of the almost upper side half of the image recording drum 52, the duct 62A is configured to control the temperature of the image recording drum 52 by blowing the air conditioning air to the area of the almost lower side half of the image recording drum 52. Specifically, a blow-off port of the duct 62A is formed in an arc shape so as to cover the almost lower side half of the image recording drum 52, and is configured to blow the air conditioning air to the area of the almost lower side half of the image recording drum 52.

Here, for the temperature control of the image recording drum 52, the temperature is controlled to be a temperature which is determined by a relationship with the temperature of the inkjet heads 56C, 56M, 56Y and 56K (the temperature of the nozzle surface in particular), and is lower than the temperature of the inkjet heads 56C, 56M, 56Y and 56K. Thus, dew condensation is prevented from being generated on the inkjet heads 56C, 56M, 56Y and 56K. That is, by making the temperature of the image recording drum 52 be lower than that of the inkjet heads 56C, 56M, 56Y and 56K, the dew condensation can be induced on an image recording drum side, and the dew condensation generated on the inkjet heads 56C, 56M, 56Y and 56K (the dew condensation generated on the nozzle surface in particular) can be prevented.

The image recording part 18 is configured as above. The paper P delivered from the process liquid drying processing drum 46 of the process liquid drying processing part 16 is received by the image recording drum 52. The image recording drum 52 transports the paper P by gripping the distal end of the paper P by the gripper 52A and being rotated. The paper P delivered to the image recording drum 52 is closely attached to the peripheral surface of the image recording drum 52 by passing through the paper pressing roller 54. Simultaneously with it, the paper P is sucked from the adsorption holes of the image recording drum 52 and adsorbed and held on the outer peripheral surface of the image recording drum 52. The paper P is transported in the state, and passes through the individual inkjet heads 56C, 56M, 56Y and 56K. Then, when the paper P passes through, the droplets of the ink of the individual colors C, M, Y and K are jetted from the individual inkjet heads 56C, 56M, 56Y and 56K to the surface, and a color image is drawn on the surface. Since the ink aggregation layer is formed on the surface of the paper P, the high-quality image can be recorded without causing feathering, bleeding or the like.

The paper P on which the image is recorded by the inkjet heads 56C, 56M, 56Y and 56K then passes through the inline sensor 58. Then, the image recorded on the surface is read when the paper P passes through the inline sensor 58. The recorded image is read as needed, and a discharge defect or the like is inspected from the read image. When performing read, since the read is performed in the state of being adsorbed and held by the image recording drum 52, the read can be highly accurately performed. Also, since the read is performed immediately after the image is recorded, for example, abnormality such as a discharge defect can be immediately detected and the coping can be quickly performed. Thus, useless recording can be prevented, and generation of broke can be minimized.

Thereafter, the paper P is delivered to the ink drying processing part 20 after the adsorption is released.

### Ink Drying Processing Part

The ink drying processing part 20 performs the drying processing to the paper P after the image is recorded, and removes a liquid component remaining on the surface of the paper P. The ink drying processing part 20 includes a chain gripper 64 that holds and transports the distal end of the paper P on which the image is recorded, a guide part (paper guide unit) 66 that guides the paper P transported by the chain gripper 64, and an ink drying processing unit 68 that performs the drying processing to the paper P transported by the chain gripper 64.

The chain gripper 64 is a paper transporting mechanism used in common in the ink drying processing part 20, the UV irradiation processing part 22, and the paper discharge part 24, receives the paper P delivered from the image recording part 18, and transports it to the paper discharge part 24.

The chain gripper 64 mainly includes a first sprocket 64A installed closely to the image recording drum 52, a second sprocket 64B installed at the paper discharge part 24, an endless chain 64C wound around the first sprocket 64A and the second sprocket 64B, a plurality of chain guides (not illustrated) that guide traveling of the chain 64C, and a plurality of grippers 64D attached at fixed intervals to the chain 64C. The first sprocket 64A, the second sprocket 64B, the chain 64C and the chain guides are configured respectively in a pair, and disposed on both sides of the width direction of the paper P (the direction orthogonal to the transporting direction of the paper P and parallel with the transporting surface (guide surface) where the back surface of the transported paper P is along: hereinafter, called a paper width direction). The grippers 64D are installed by being wound around a pair of endless chains 64C arranged side by side in the paper width direction.

Also, the grippers 64D correspond to the paper gripping unit that grips the paper, and the first sprocket 64A, the second sprocket 64B and the endless chain 64C that move the grippers 64D in the transporting direction of the paper P correspond to the transporting unit.

The first sprocket 64A is installed closely to the image recording drum 52 so as to receive the paper P delivered from the image recording drum 52 by the grippers 64D. The first sprocket 64A is pivotally supported by a bearing which is not illustrated, provided freely rotatably around a rotary axis in parallel with a rotary axis of the image recording drum 52, and connected to a motor which is not illustrated. The chain 64C wound around the first sprocket 64A and the second sprocket 64B is made to travel by driving the motor.

The second sprocket 64B is installed at the paper discharge part 24 so as to collect the paper P received from the image recording drum 52 by the paper discharge part 24. That is, an installation position of the second sprocket 64B is a terminating end of the transporting route of the paper P by the chain gripper 64. The second sprocket 64B is pivotally supported by a bearing which is not illustrated, and provided freely rotatably around a rotary axis in parallel with the rotary axis of the first sprocket 64A. However, the rotary axes of the first sprocket 64A and the second sprocket 64B are not limited to the case of being in parallel.

The chain 64C is formed in the endless shape, and wound around the first sprocket 64A and the second sprocket 64B.

The chain guides are arranged at prescribed positions and guide the chain 64C to travel through a prescribed route (=guide the paper P to travel and be transported through the prescribed transporting route). In the inkjet recorder 10 of this case, the second sprocket 64B is disposed at a position higher than the first sprocket 64A. Therefore, the traveling route in which the chain 64C is inclined in the middle is formed. Specifically, the route includes a first horizontal transporting route 70A, an inclined transporting route 70B, and a second horizontal transporting route 70C.

The first horizontal transporting route 70A is set at the same height as the first sprocket 64A, and is set so that the chain 64C wound around the first sprocket 64A horizontally travels.

The second horizontal transporting route 70C is set at the same height as the second sprocket 64B, and is set so that the chain 64C wound around the second sprocket 64B horizontally travels.

The inclined transporting route 70B is set between the first horizontal transporting route 70A and the second horizontal transporting route 70C, and is set so as to connect the first horizontal transporting route 70A and the second horizontal transporting route 70C.

The chain guides are disposed so as to form the first horizontal transporting route 70A, the inclined transporting route 70B, and the second horizontal transporting route 70C. Specifically, they are disposed at least at a junction point of the first horizontal transporting route 70A and the inclined transporting route 70B, and a junction point of the inclined transporting route 70B and the second horizontal transporting route 70C.

The plurality of grippers 64D are attached at fixed intervals along the chain 64C. An attaching interval of the individual grippers 64D is set matched with an interval of receiving the paper P from the image recording drum 52. That is, it is set matched with the interval of receiving the paper P from the image recording drum 52 so as to receive the paper P successively delivered from the image recording drum 52 from the image recording drum 52 at the same timing. Also, a configuration related to the grippers 64D will be described later.

The chain gripper 64 is configured as above. As described above, when the motor (not illustrated) connected to the first sprocket 64A is driven, the chain 64C travels. The chain 64C travels at the same speed as the peripheral speed of the image recording drum 52. Also, the timing is matched so as to receive the paper P delivered from the image recording drum 52 by the individual grippers 64D (for this adjustment, the adjustment is performed at an installation position of a claw opening/closing cam 118).

The guide part 66 includes the guide plate (paper guide unit) 72 that performs guiding along the transporting direction of the paper P (the direction in parallel with the traveling direction of the chain 64C: hereinafter, called the paper transporting direction) while keeping the posture (shape) of the paper P transported while being gripped by the chain gripper 64 at the distal end flat.

Though detail of the guide plate 72 will be described later, as a surface to be the transporting surface of the paper P, the guide surface which has a width corresponding to the paper width regarding the paper width direction and is along a flat surface (that is, a plane) is provided. The guide plate 72 is arranged along the transporting route of the paper P by the chain gripper 64, that is, the traveling route of the chain 64C, and the guide surface is arranged along the plane in parallel with the paper transporting direction and the paper width direction. Specifically, it is arranged along the chain 64C that travels through the first horizontal transporting route 70A and the inclined transporting route 70B.

The paper P transported by the chain gripper 64 is held in a flat shape along the plane in parallel with the paper transporting direction and the paper width direction in the transporting routes 70A and 70B in the ink drying processing part 20 and the UV irradiation processing part 22, by being transported while the back surface (the surface on the side where the image is not recorded) is in sliding contact (contact) with the guide surface of the guide plate 72. Thus, the paper P is not dried in a warped state, and the situation that the printed paper P is curled is prevented.

The ink drying processing unit 68 is installed inside the chain gripper 64 (in particular, a part configuring the first horizontal transporting route 70A) and executes the drying processing to the paper P transported through the first horizontal transporting route 70A. The ink drying processing unit 68 includes a hot air blower, and performs the drying processing by blowing the hot air to the surface of the paper P transported through the first horizontal transporting route 70A. The plurality of ink drying processing units 68 are arranged along the first horizontal transporting route 70A. The installation number is set according to throughput of the ink drying processing unit 68, the transporting speed (=printing speed) of the paper P, or the like. That is, it is set so that the paper P received from the image recording part 18 can be dried while being transported through the first horizontal transporting route 70A. Therefore, a length of the first horizontal transporting route 70A is also set in consideration of the ability of the ink drying processing unit 68.

Also, by performing the drying processing, humidity of the ink drying processing part 20 rises. Since the drying processing cannot be performed efficiently when the humidity rises, it is preferable to install an exhaust unit together with the ink drying processing units 68 in the ink drying processing part 20, and to forcibly exhaust humid air generated by the drying processing. The exhaust unit can be configured that an exhaust duct is installed to the ink drying processing part 20 and the air of the ink drying processing part 20 is exhausted by the exhaust duct, for example.

The ink drying processing part 20 is configured as above. The paper P delivered from the image recording drum 52 of the image recording part 18 is received by the chain gripper 64. The chain gripper 64 grips the distal end of the paper P by the grippers 64D, and transports the paper P. The paper P delivered to the chain gripper 64 is transported through the first horizontal transporting route 70A first. In the process of being transported through the first horizontal transporting route 70A, to the paper P, the drying processing is executed by the ink drying processing units 68 installed inside the chain gripper 64. That is, the drying processing is executed by blowing the hot air to the surface (image recording surface). At the time, since the paper P is transported while being held in the flat shape by the guide part 66, the drying processing can be performed while suppressing the deformation of the paper P.

### UV Irradiation Processing Part

The UV irradiation processing part 22 irradiates the image recorded using the aqueous UV ink with the ultraviolet ray (UV) and fixes the image. The UV irradiation processing part 22 mainly includes the chain gripper 64 that transports the paper P to which the drying processing is performed, the guide part 66 that guides the paper P transported by the chain gripper 64, and a UV irradiation unit 74 that irradiates the paper P transported by the chain gripper 64 with the ultraviolet ray.

As described above, the chain gripper 64 is shared by the ink drying processing part 20 and the paper discharge part 24, and the guide part 66 is a configuration part having the configuration and an action equal to the guide part 66 of the ink drying processing part 20.

The UV irradiation unit 74 is installed inside the chain gripper 64 (in particular, a part configuring the inclined transporting route 70B) and irradiates the surface of the paper P transported through the inclined transporting route 70B with the ultraviolet ray. The UV irradiation unit 74 includes an ultraviolet ray lamp (UV lamp), and the plurality of UV irradiation units 74 are disposed along the inclined transporting route 70B. Then, the surface of the paper P transported through the inclined transporting route 70B is irradiated with the ultraviolet ray. The installation number of the UV irradiation units 74 is set according to the transporting speed (=printing speed) of the paper P or the like. That is, it is set so as to fix the image by the ultraviolet ray irradiated while the paper P is transported through the inclined transporting route 70B. Therefore, a length of the inclined transporting route 70B is also set in consideration of the transporting speed of the paper P or the like.

The UV irradiation processing part 22 is configured as above. The paper P transported by the chain gripper 64 and subjected to the drying processing in the ink drying processing part 20 is then transported through the inclined transporting route 70B. In the processing of being transported through the inclined transporting route 70B, to the paper P, UV irradiation processing is executed by the UV irradiation units 74 installed inside the chain gripper 64. That is, the surface is irradiated with the ultraviolet ray from the UV irradiation units 74.

### Paper Discharge Part

The paper discharge part 24 collects the paper P to which a series of image recording processing is performed. The paper discharge part 24 mainly includes the chain gripper 64 that transports the paper P irradiated with the UV, and a paper discharge base 76 where the paper P is stacked and collected.

As described above, the chain gripper 64 is shared by the ink drying processing part 20 and the UV irradiation processing part 22. The chain gripper 64 releases the paper P on the paper discharge base 76 to stack the paper P on the paper discharge base 76.

The paper discharge base 76 stacks and collects the paper P released from the chain gripper 64. In order to stack the paper P in order, the paper discharge base 76 is provided with paper contacts (a front paper contact, a rear paper contact, a side paper contact or the like) (not illustrated).

Also, the paper discharge base 76 is provided so as to be elevated and lowered by a paper discharge base elevating and lowering device not illustrated. The drive of the paper discharge base elevating and lowering device is controlled in linkage with increase/decrease of the paper P stacked on the paper discharge base 76 to elevate and lower the paper discharge base 76 so that the paper P positioned at the top is positioned at a fixed height at all times.

### Control System

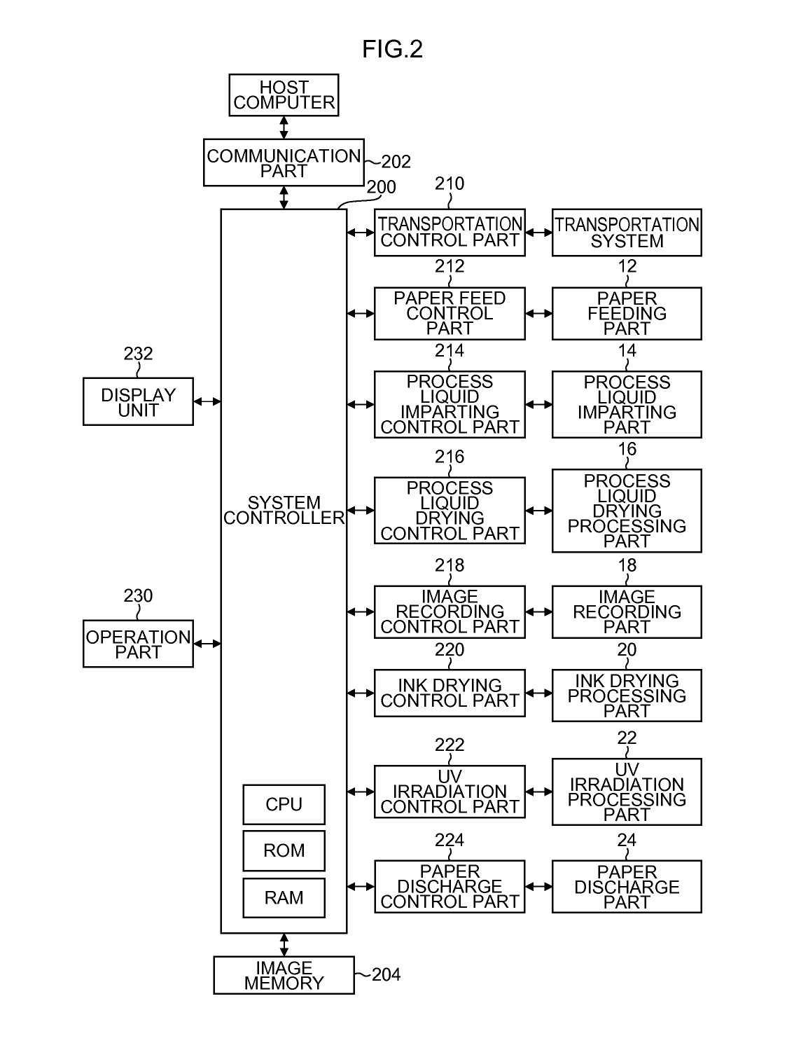

FIG. 2 is a block diagram illustrating a schematic configuration of a control system of the inkjet recorder 10 of the present embodiment.

As illustrated in the figure, the inkjet recorder 10 includes a system controller 200, a communication part 202, an image memory 204, a transportation control part 210, a paper feed control part 212, a process liquid imparting control part 214, a process liquid drying control part 216, an image recording control part 218, an ink drying control part 220, a UV irradiation control part 222, a paper discharge control part 224, an operation part 230, a display part 232, or the like.

The system controller 200 functions as a control unit that generally controls the individual parts of the inkjet recorder 10, and also functions as an arithmetic unit that performs various kinds of arithmetic processing. The system controller 200 includes a CPU (Central Processing Unit), a ROM (Read Only Memory), a RAM (Random Access Memory) or the like, and is operated according to a prescribed control program. In the ROM, a control program to be executed by the system controller 200 and various kinds of data required for control are stored.

The communication part 202 includes a required communication interface, and transmits and receives the data to/from a host computer connected with the communication interface.

The image memory 204 functions as a temporary storage unit of the various kinds of data including image data, and the data is read and written through the system controller 200. The image data fetched from the host computer through the communication part 202 is stored in the image memory 204.

The transportation control part 210 controls a transportation system of the paper P in the inkjet recorder 10. That is, the drive of the tape feeders 36A, the front contact 38 and the paper feeding drum 40 in the paper feeding part 12 is controlled, and the drive of the process liquid imparting drum 42 in the process liquid imparting part 14, the process liquid drying processing drum 46 in the process liquid drying processing part 16, and the image recording drum 52 in the image recording part 18 are controlled. Also, the drive of the chain gripper 64 used in common in the ink drying processing part 20, the UV irradiation processing part 22 and the paper discharge part 24 is controlled.

The transportation control part 210 controls the transportation system according to a command from the system controller 200, and performs control so that the paper P is transported smoothly from the paper feeding part 12 to the paper discharge part 24.

The paper feed control part 212 controls the paper feeding part 12 according to a command from the system controller 200. Specifically, the drive of the sucker device 32 and a paper feeding base elevating and lowering mechanism or the like are controlled, and the control is performed so that the paper P loaded on the paper feeding base 30 is fed in order sheet by sheet without being overlapped.

The process liquid imparting control part 214 controls the process liquid imparting part 14 according to a command from the system controller 200. Specifically, the drive of the process liquid imparting unit 44 is controlled so that the process liquid is applied to the paper P transported by the process liquid imparting drum 42.

The process liquid drying control part 216 controls the process liquid drying processing part 16 according to a command from the system controller 200. Specifically, the drive of the process liquid drying processing unit 50 is controlled so that the drying processing is performed to the paper P transported by the process liquid drying processing drum 46.

The image recording control part 218 controls the image recording part 18 according to a command from the system controller 200. Specifically, the drive of the inkjet heads 56C, 56M, 56Y and 56K is controlled so that a prescribed image is recorded on the paper P transported by the image recording drum 52. Also, the operation of the inline sensor 58 is controlled so that the recorded image is read.

The ink drying control part 220 controls the ink drying processing part 20 according to a command from the system controller 200. Specifically, the drive of the ink drying processing units 68 is controlled so that the hot air is blown to the paper P transported by the chain gripper 64.

The UV irradiation control part 222 controls the UV irradiation processing part 22 according to a command from the system controller 200. Specifically, the drive of the UV irradiation unit 74 is controlled so that the paper P transported by the chain gripper 64 is irradiated with the ultraviolet ray.

The paper discharge control part 224 controls the paper discharge part 24 according to a command from the system controller 200. Specifically, the drive of a paper discharge base elevating and lowering mechanism or the like is controlled, and the control is performed so that the paper P is stacked on the paper discharge base 76.

The operation part 230 includes a required operation unit (for example, an operation button, a keyboard, a touch panel, or the like), and outputs operation information inputted from the operation unit to the system controller 200. The system controller 200 executes various kinds of processing according to the operation information inputted from the operation part 230.

The display part 232 includes a required display device (for example, an LCD (Liquid Crystal Display) panel or the like), and makes required information be displayed at the display device according to a command from the system controller 200.

As described above, the image data to be recorded on the paper is fetched from the host computer to the inkjet recorder 10 through the communication part 202. The fetched image data is stored in the image memory 204.

The system controller 200 generates dot data by executing required signal processing to the image data stored in the image memory 204. Then, the drive of the individual inkjet heads 56C, 56M, 56Y and 56K in the image recording part 18 is controlled according to the generated dot data, and the image expressed by the image data is recorded on the paper.

The dot data is generated generally by performing color conversion processing and halftone processing to the image data. The color conversion processing is the processing of converting the image data (for example, the image data of RGB 8 bits) expressed by sRGB (standard RGB (International Electrotechnical Commission)) or the like to ink amount data of the individual colors of the ink to be used in the inkjet recorder 10 (in this case, conversion to the ink amount data of the individual colors of C, M, Y and K). The halftone processing is the processing of performing conversion to the dot data of the individual colors by the processing of error diffusion or the like to the ink amount data of the individual colors generated by the color conversion processing.

The system controller 200 generates the dot data of the individual colors by performing the color conversion processing and the halftone processing to the image data. Then, by controlling the drive of the corresponding inkjet heads according to the generated dot data of the individual colors, the image expressed by the image data is recorded on the paper.

### Action

The actions of the inkjet recorder 10 in the present embodiment configured as above are as follows.

When start of a printing job is instructed to the system controller 200 through the operation part 230, the processing of cycle-up is performed. That is, a preparing operation is performed in the individual parts so as to perform a stable operation.

When the cycle-up is completed, printing processing is started. That is, the paper P is successively fed from the paper feeding part 12.

In the paper feeding part 12, the paper P loaded on the paper feeding base 30 is fed by the sucker device 32 sheet by sheet in order from the top. The paper P fed from the sucker device 32 is mounted on the feeder board 36 sheet by sheet through the paper feeding roller pair 34.

The paper P mounted on the feeder board 36 is supplied with feed force by the tape feeders 36A provided on the feeder board 36, and is transported to the paper feeding drum 40 while sliding on the feeder board 36. At the time, the successively fed paper P is transported to the paper feeding drum 40 while sliding on the feeder board 36 sheet by sheet without being overlapped with each other. Also, in the transportation process, the upper surface is pressed toward the feeder board 36 by the retainer 36B. Thus, the ruggedness of the paper P is corrected.

The paper P transported to the terminating end of the feeder board 36 is delivered to the paper feeding drum 40 after the distal end is brought into contact with the front contact 38. Thus, the paper P can be fed to the paper feeding drum 40 in a fixed posture without generating inclinations.

The paper feeding drum 40 receives the paper P by gripping the distal end of the paper P by the gripper 40A while being rotated, and transports the paper P to the process liquid imparting part 14.

The paper P transported to the process liquid imparting part 14 is delivered from the paper feeding drum 40 to the process liquid imparting drum 42.

The process liquid imparting drum 42 grips and receives the distal end of the paper P by the gripper 40A while being rotated, and transports the paper P to the process liquid drying processing part 16. For the paper P, the coating roller 44A is pressurized and brought into contact with the surface in the process of being transported by the process liquid imparting drum 42, and the process liquid is imparted (applied) to the surface of the paper P.

The paper P for which the process liquid is imparted to the surface is delivered from the process liquid imparting drum 42 to the process liquid drying processing drum 46.

The process liquid drying processing drum 46 grips and receives the distal end of the paper P while being rotated, and transports the paper P to the image recording part 18. For the paper P, the hot air blown from the process liquid drying processing unit 50 is blown to the surface in the process of being transported by the process liquid drying processing drum 46, and the drying processing is performed. Thus, the solvent component in the process liquid is removed, and the ink aggregation layer is formed on the surface (image recording surface) of the paper P.

The paper P to which the drying processing of the process liquid is executed is delivered from the process liquid drying processing drum 46 to the image recording drum 52.

The image recording drum 52 grips and receives the distal end of the paper P while being rotated, and transports the paper P to the ink drying processing part 20. For the paper P, the droplets of the ink of the individual colors of C, M, Y and K are jetted to the surface by the inkjet heads 56C, 56M, 56Y and 56K in the process of being transported by the image recording drum 52, and the image is recorded. Also, the image recorded in the transportation process is read by the inline sensor 58. At the time, the paper P is transported while being adsorbed and held on the peripheral surface of the image recording drum 52. Then, in the state of being sucked and held, the image is recorded and the recorded image is read. Thus, the image can be recorded highly accurately, and the image can be read highly accurately.

The paper P on which the image is recorded is delivered from the image recording drum 52 to the chain gripper 64.

The chain gripper 64 grips the distal end of the paper P by the grippers 64D provided on the traveling chain 64C, receives the paper P, and transports it to the paper discharge part 24.

For the paper P, in the transportation process by the chain gripper 64, the drying processing of the ink is executed first. That is, the hot air is blown to the surface from the ink drying processing units 68 installed in the first horizontal transporting route 70A. Thus, the drying processing is executed. At the time, since the paper P is transported while being held in the flat shape by the guide part 66, the drying processing can be performed while suppressing the deformation of the paper P.

For the paper P for which the drying processing is ended (the paper P which has passed through the ink drying processing part 20), the UV irradiation processing is executed next. That is, the ultraviolet ray is irradiated toward the surface from the UV irradiation unit 74 installed in the inclined transporting route 70B. Thus, the ink configuring the image is cured, and the image is fixed to the paper P. At the time, since the paper P is transported while being held in the flat shape by the guide part 66, fixing processing can be performed while suppressing the deformation of the paper P.

The paper P for which the UV irradiation processing is ended (the paper P which has passed through the UV irradiation processing part 22) is transported to the paper discharge part 24, released from the grippers 64D in the paper discharge part 24, and stacked on the paper discharge base 76.

By the series of operations above, the recording processing of the image is completed. As described above, since the paper P is continuously fed from the paper feeding part 12, in the individual parts, the continuously fed paper P is continuously processed, and the recording processing of the image is performed.

As described above, according to the inkjet recorder 10 of the present embodiment, the paper P on which the image is recorded is received from the image recording part 18 by the chain gripper 64, and the drying processing of the ink is performed in the transportation process by the chain gripper 64. The chain gripper 64 has a degree of freedom in setting of the transporting route of the paper, and the ink drying processing units 68 can be arranged in a high density. Thus, even in the case of transporting the paper P at a high speed, the paper P after the image is recorded can be efficiently dried in a short time, and dried before the ink permeates the paper P. Thus, the deformation of the paper P can be suppressed.

Also, since the drying processing is performed in the transporting unit (the chain gripper 64 in this case) different from the transporting unit for recording the image (the image recording drum 52 in this case), rise of the temperature of the transporting unit for recording the image by heat generated during the drying processing can be suppressed. Thus, generation of dew condensation on the inkjet heads and acceleration of drying of nozzles can be effectively prevented.

### Configuration of Chain Gripper and Guide Part

Next, the paper transporting mechanism (paper transporting device) by the chain gripper 64 used in common in the ink drying processing part 20, the UV irradiation processing part 22, and the paper discharge part 24 and the guide part 66 provided for the chain gripper 64 will be described in detail.

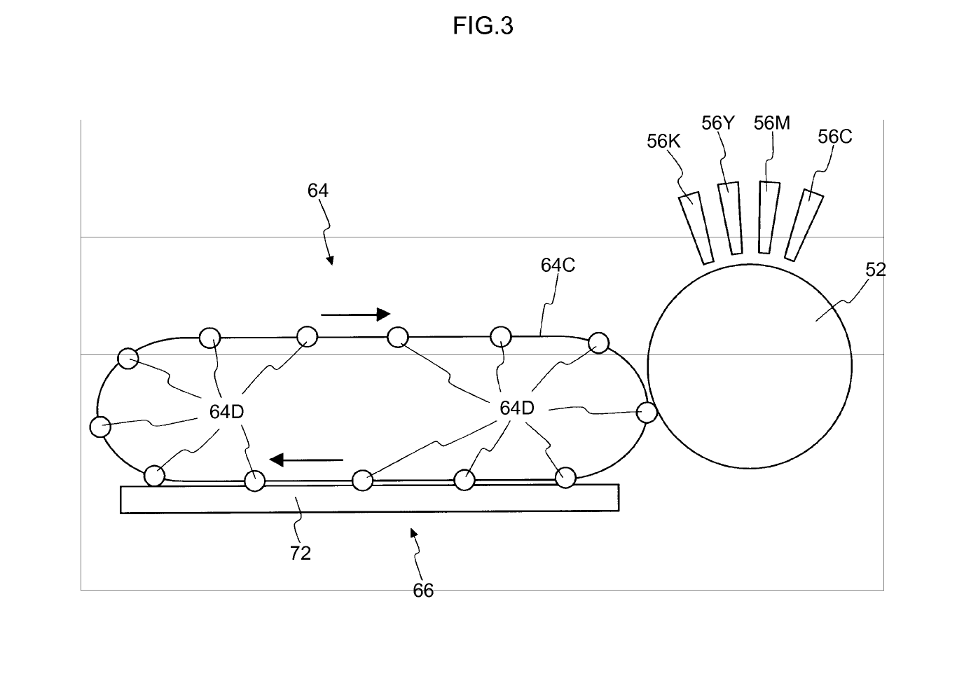

FIG. 3 is a side view simplifying and illustrating the paper transporting mechanism of the ink drying processing part 20, the UV irradiation processing part 22, and the paper discharge part 24, and the image recording drum 52 in the paper transporting mechanism of the image recording part 18 and the inkjet heads 56C, 56M, 56Y and 56K in the image recording part 18 are also illustrated together.

In the figure, a traveling route of the chain 64C of the chain gripper 64 is simplified and illustrated by a rounded rectangle, and the grippers 64D attached at positions at fixed intervals along the chain 64C are illustrated by circular graphics.

Below, it is assumed that the chain 64C and the grippers 64D travel along the traveling route as in FIG. 3. Then, it is assumed that the paper P received from the image recording drum 52 of the image recording part 18 is transported to the paper discharge part 24 by the grippers 64D traveling along a long side portion on a lower side (paper transporting part) of two upper and lower long side portions of the traveling route, that is, the grippers 64D moved to the downstream side of the paper transporting direction.

Also, in the figure, at a position along the traveling route to be the paper transporting part of the chain 64C of the chain gripper 64, the guide plate 72 (fixing member) of the guide part 66 is illustrated. The guide plate 72 illustrates the guide plate 72 separated into the first horizontal transporting route 70A and the inclined transporting route 70B and arranged in FIG. 1, and it is assumed below that these guide plates 72 are integrally configured as in FIG. 3.

In the paper transporting mechanism like this, the chain 64C is rotated (circulated) clockwise in FIG. 3 by the rotation of the motor of the first sprocket 64A illustrated in FIG. 1, and in linkage with that, the individual grippers 64D are circulated clockwise along the traveling route of the chain 64C.

The gripper 64D approaches the image recording drum 52 at a position to be the almost center of a semicircular part on a right side where the first sprocket 64A is arranged in the traveling route of the chain 64C, and at the position, grips the distal end of the paper P transported by being wound around the image recording drum 52 and receives the paper P.

The gripper 64D that receives the paper P is moved to the downstream side of the paper transporting direction along the traveling route of the long side portion on the lower side to be the paper transporting part in the state of gripping the distal end of the paper P.

Then, when a position to be the lower side of the traveling route of a semicircular part on a left side where the second sprocket 64B illustrated in FIG. 1 is arranged is reached, the gripped paper P is released. Thus, the paper P is transported to the paper discharge part 24, and the paper P is stacked on the paper discharge base 76.

Also, as described later in detail, when the gripper 64D gripping the paper P is being moved along the traveling route of the paper transporting part, the paper P is transported while being held in the flat shape along the transporting surface (guide surface) in parallel with the paper transporting direction and the paper width direction by the guide plate 72 of the guide part 66.

### Configuration Example of Gripper

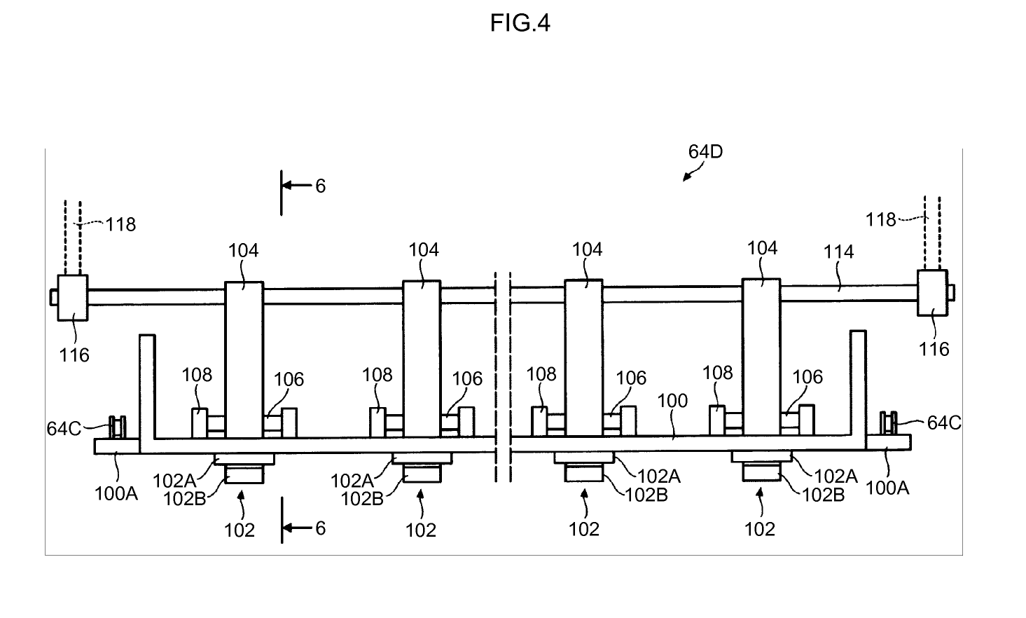

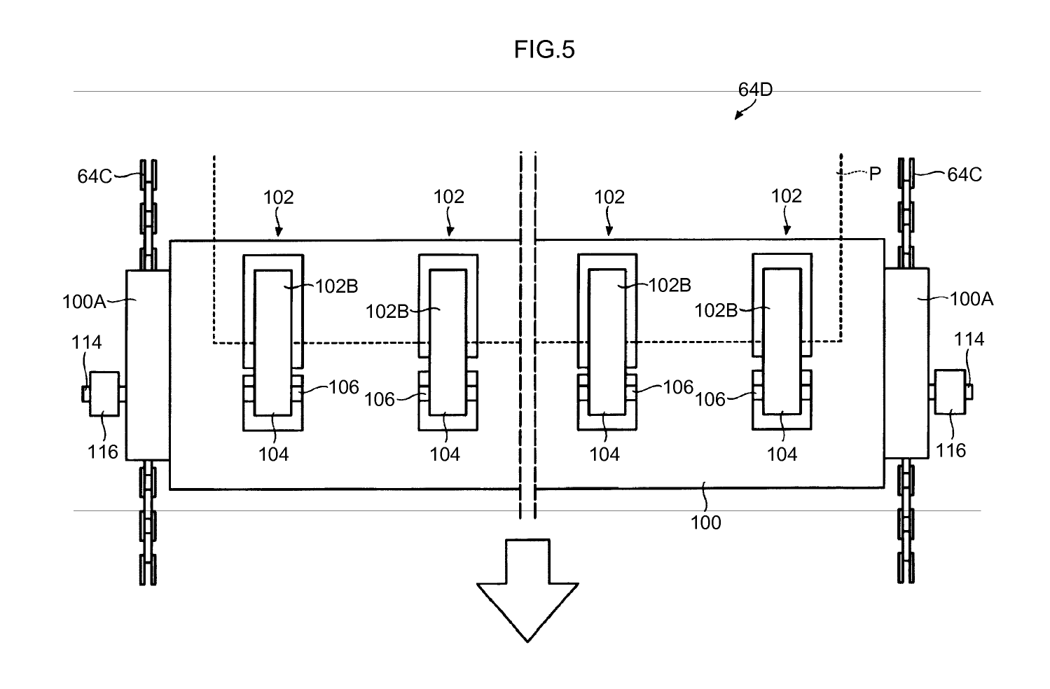

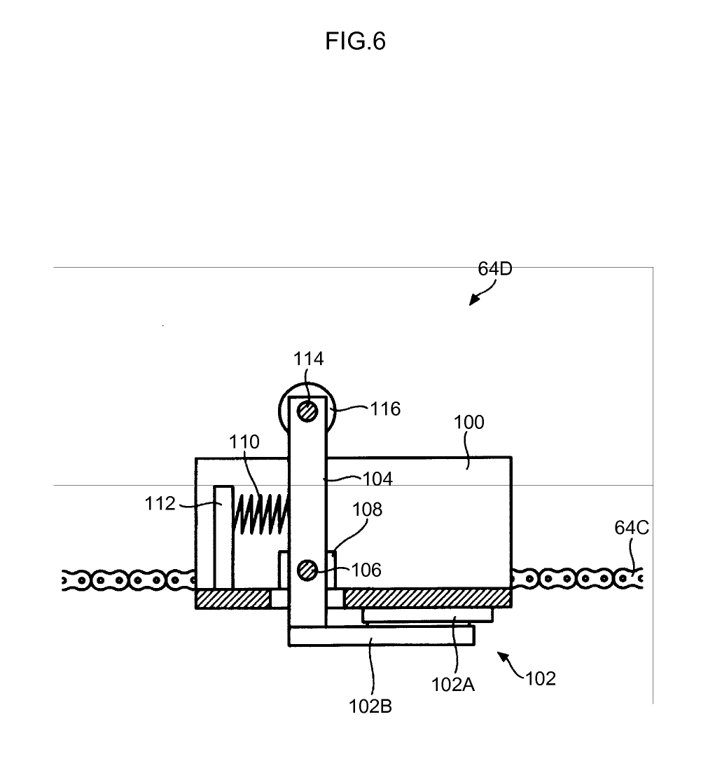

Here, one example of a configuration of the gripper 64D will be illustrated. FIG. 4 and FIG. 5 are a front view and a plan view (diagram viewing FIG. 4 from below) illustrating a configuration of the gripper 64D respectively, and FIG. 6 is a sectional view on arrows 6-6 in FIG. 4.

As illustrated in these figures, the gripper 64D mainly includes a base frame 100 attached to the chain 64C, and a plurality of claw parts 102 attached at fixed intervals to the base frame 100.

The base frame 100 includes connection parts 100A at both ends, and the connection parts 100A are attached orthogonally to each of the pair of chains 64C. Thus, the base frame 100 is disposed and arranged between the pair of chains 64C along the paper width direction.

The plurality of claw parts 102 are arranged at positions at the fixed intervals along the paper width direction to the base frame 100.

Also, the individual claw parts 102 are arranged so as to be bilaterally symmetrical to the center in the paper width direction of the base frame 100.

The claw part 102 includes a fixed claw (claw seat) 102A and a movable claw 102B, and the fixed claw 102A is fixed to the base frame 100 and installed.

On the other hand, the movable claw 102B is attached to a distal end of a claw opening/closing lever 104.

The claw opening/closing lever 104 includes a claw opening/closing rotary shaft 106, and is provided freely swingably (freely rotatably) around the claw opening/closing rotary shaft 106.

The claw opening/closing rotary shaft 106 is pivotally supported by a bearing part 108 formed on the base frame 100.

Therefore, by swinging the claw opening/closing lever 104, the movable claw 102B is vertically moved to the fixed claw 102A, and the claw part 102 is opened and closed.

Also, one end of a claw opening/closing spring 110 is connected to the claw opening/closing lever 104, and the other end of the claw opening/closing spring 110 is connected to a claw opening/closing spring support part 112 provided on the base frame 100.

Since the claw opening/closing spring 110 urges the claw opening/closing lever 104 so as to be pulled toward the claw opening/closing spring support part 112, by the claw opening/closing spring 110, the claw opening/closing lever 104 is urged in a direction of closing the claw part 102 (urged in a direction of bringing the movable claw 102B into contact with the fixed claw 102A).

A base end of the claw opening/closing lever 104 of each claw part 102 is connected to a common cam follower shaft 114 arranged in parallel with the paper transporting direction.

To both ends of the cam follower shaft 114, a cam follower 116 is attached.

Therefore, by engagement of the cam follower 116 with a claw opening/closing cam 118 arranged on the traveling route of the gripper 64D, the claw opening/closing lever 104 is swung, and the claw part 102 is opened and closed.

The claw opening/closing cam 118 is arranged at a position of receiving the paper P and a position of opening the paper P. Specifically, the claw opening/closing cam 118 is arranged at a position of receiving the paper P from the image recording drum 52 (the position of the first sprocket 64A in FIG. 1), and a position of discharging the paper P at the paper discharge part 24 (the position of the second sprocket 64B in FIG. 1).

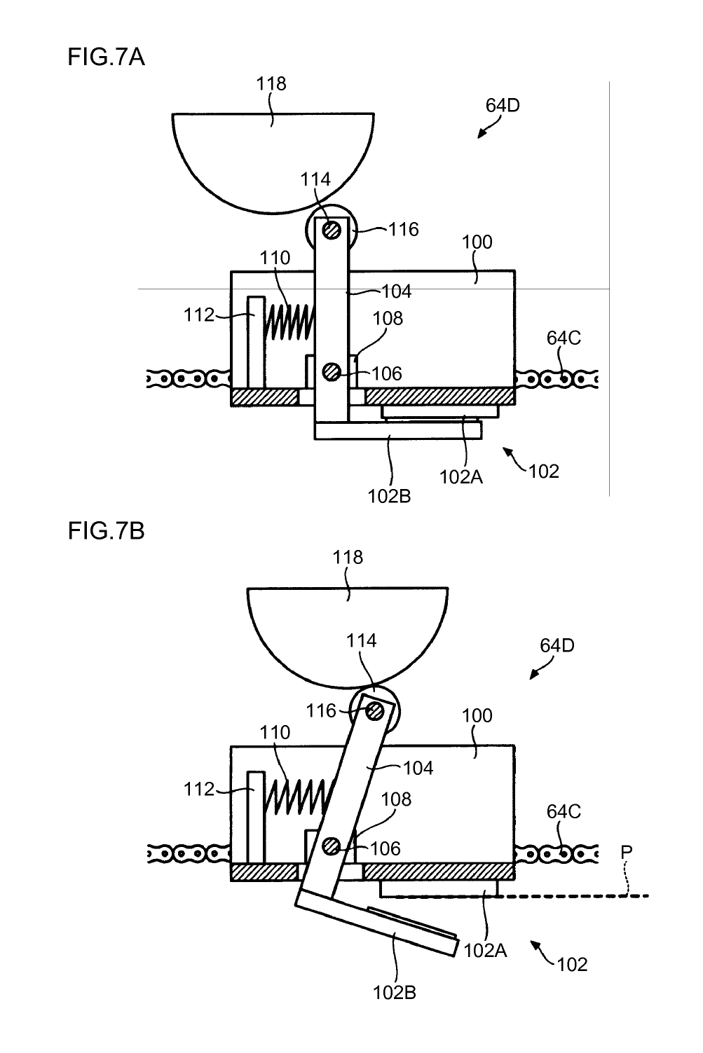

When the chain 64C travels and the cam follower 116 is engaged with the claw opening/closing cam 118, the claw opening/closing lever 104 is swung and each claw part 102 is opened and closed. Thus, it is possible to grip or release the paper P by each claw part 102. Specifically, as in state transition from FIG. 7A to FIG. 7B, by the cam follower 116 getting on the claw opening/closing cam 118, the claw opening/closing lever 104 is swung against urging force of the claw opening/closing spring 110, and the movable claw 102B is moved in a direction of separating from the fixed claw 102A. That is, the claw part 102 is opened. When the cam follower 116 passes through the claw opening/closing cam 118, the claw opening/closing lever 104 is swung in an opposite direction by the urging force of the claw opening/closing spring 110, and the movable claw 102B is moved in a direction of approaching the fixed claw 102A. That is, the claw part 102 is closed.

The configuration of the gripper 64D described using FIG. 4 to FIG. 7A and FIG. 7B above is one example, and an arbitrary one of a well-known configuration can be adopted as the gripper 64D.

### Guide Part in First Embodiment

Next, the first embodiment of the guide part 66 (guide plate 72) will be described.

The guide plate 72 illustrated in FIG. 3 is a planar member including the guide surface along a flat surface (plane) on an upper surface side (the side where the chain gripper 64 is arranged), and is arranged along the traveling route of the long side portion on the lower side to be the paper transporting part of the traveling route of the chain 64C of the chain gripper 64.

By this, the guide surface of the guide plate 72 is arranged as the transporting surface of the paper P in parallel with the paper transporting direction and the paper width direction, to an arrangement side of the chain gripper 64.

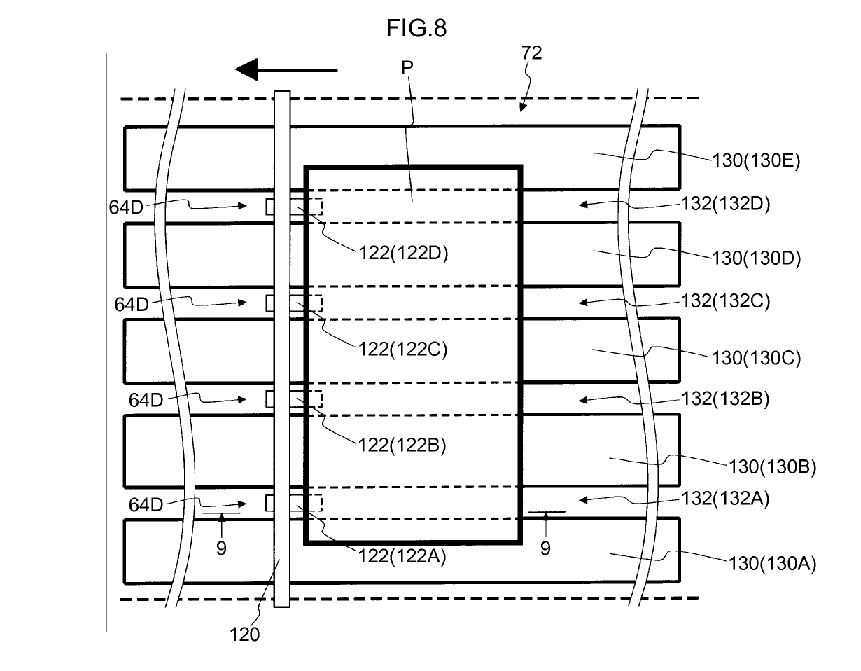

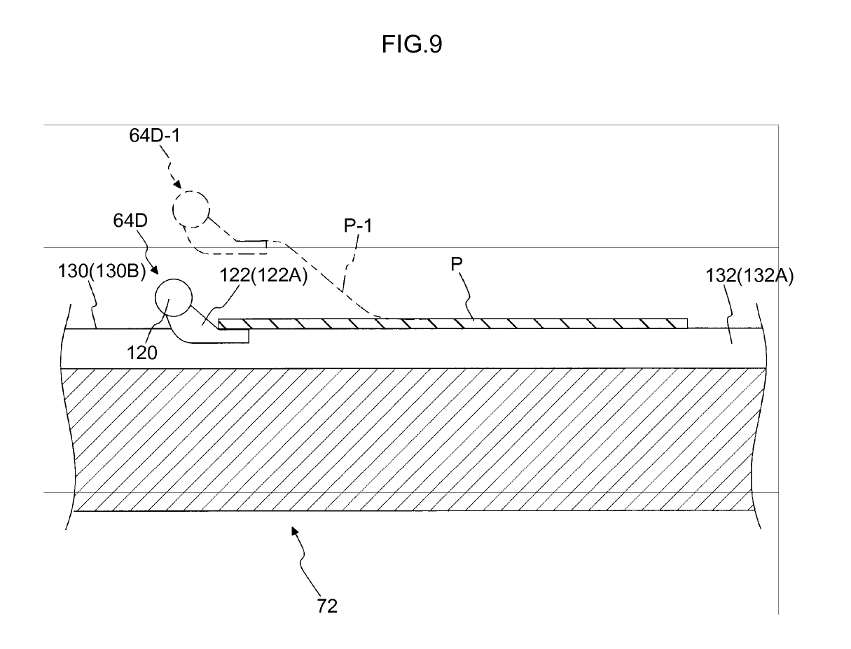

FIG. 8 is a plan view illustrating the upper surface side of the guide plate 72, and FIG. 9 is a sectional view on arrows 9-9 in FIG. 8.

Also, in these figures, as components of the chain gripper 64, a gripper shaft 120 disposed in the paper width direction to the pair of chains 64C and claw members 122 which are the movable claws provided freely swingably to the gripper shaft 120 among the fixed claws and the movable claws of the claw parts that grip the paper P only are illustrated.

The gripper shaft 120 corresponds to the one indicating the individual claw opening/closing rotary shafts 106 of the plurality of grippers 64D supported by the chain 64C through one base frame 100 as one shaft in a configuration example of the gripper 64D illustrated in FIG. 4 to FIG. 7A and FIG. 7B, and the claw member 122 corresponds to the claw opening/closing lever 104 (a part of the claw opening/closing lever 104) provided freely swingably (freely rotatably) to the individual claw opening/closing rotary shafts 106 and the movable claw 102B at the distal end.

As illustrated in FIG. 8, the gripper shaft 120 is arranged in the paper width direction at an upper part of the upper surface side of the guide plate 72, and the plurality of grippers 64D (claw members 122) are arranged at positions at fixed intervals in the paper width direction along the gripper shaft 120. In the present embodiment, the case that four grippers 64D (claw members 122A-122D) are arranged at one gripper shaft 120 is illustrated as in the figure. However, about eight grippers 64D are actually arranged, and the number of the grippers 64D may be any number.

These four grippers 64D travel to the downstream side of the paper transporting direction orthogonal to the gripper shaft 120 when transporting the paper.

In contrast, on the upper surface of the guide plate 72, five belt-like guide surfaces 130 (130A-130E) and four belt-like grooves 132 (132A-132D) extending along the paper transporting direction from an end on the upstream side to an end on the downstream side of the paper transporting direction of the guide plate 72 are formed alternately regarding the paper width direction.

The guide surfaces 130 (130A-130E) are formed over the entire range except areas where the grooves 132 (132A-132D) are formed, and are formed along a plane in parallel with the paper transporting direction and the paper width direction. Since the back surface of the paper P is moved while being in sliding contact with the guide surfaces 130, the guide surfaces 130 become the transporting surface of the paper P.

On the other hand, the grooves 132 (132A-132D) are formed in such a width that the claw members 122 (122A-122D) can enter at least at positions opposing the claw members 122 (122A-122D) of the individual grippers 64D, that is, the positions along the traveling route in the paper transporting direction where the claw members 122 (122A-122D) of the individual grippers 64D traveling in the paper transporting direction pass through, and form recesses recessed to the guide surfaces 130.

Also, as a positional relationship regarding a height direction between the guide surface 130B and the groove 132A of the guide plate 72 and the claw member 122A of the gripper 64D is illustrated in FIG. 9, a part of the lower side of the claw members 122 (122A-122D) of the individual grippers 64D enters a position lower than the position (height) in a height direction of the guide surfaces 130, that is, the inside of the respectively opposing grooves 132 (132A-132D).

Thus, the height of the distal end of the paper P gripped by the grippers 64D and the height on an end side of the paper P in sliding contact with the guide surfaces 130 become the roughly coincident height, and the entire paper P from the distal end to the end is transported while being held in the flat shape along the guide surfaces 130.

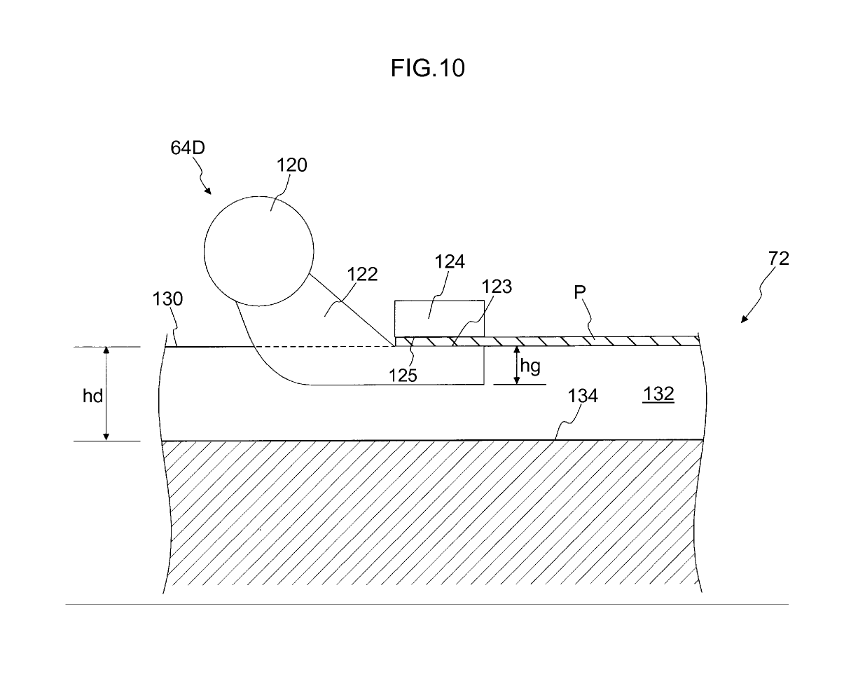

Illustrating more specifically, as illustrated in FIG. 10 for which FIG. 9 is enlarged, each gripper 64D clamps and grips the distal end of the paper P between a paper gripping surface 123 of the claw member 122 corresponding to the movable claw 102B in the configuration of the gripper 64D illustrated in FIG. 4 to FIG. 7A and FIG. 7B, and a paper gripping surface 125 of a fixed claw 124 corresponding to the fixed claw 102A in the configuration of the gripper 64D illustrated in FIG. 4 to FIG. 7A and FIG. 7B. Also, the paper gripping surfaces 123 and 125 are in parallel with the guide surface 130 and grip the paper P to the upstream side of the paper transporting direction.

Then, the guide surface 130 is arranged at the height that coincides with the height of the paper gripping surface 123 of the claw member 122 in contact with the back surface side of the paper P.

Also, when a height from the lowest point to the paper gripping surface 123 of the claw member 122 is defined as hg, and a height from a bottom surface 134 of the groove 132 to the guide surface 130 (a depth of the groove 132) is defined as hd, the depth hd of the groove 132 is formed to be larger than at least the hg. Then, a range from the lowest point to the paper gripping surface 123 of the claw member 122 enters the inside of the groove 132 (the position lower than the guide surface 130).

Thus, the paper P whose distal end is gripped by the gripper 64D is transported while being held in the flat shape along the guide surface 130 by the guide plate 72 from the distal end to the end as in FIG. 9 and FIG. 10.

For example, in the case that the groove 132 is not formed on the guide surface 130 of the guide plate 72, the guide surface 130 is installed to travel the position higher than the guide surface 130 at least so that the lowest point of the claw member 122 is not brought into contact with the guide surface 130. In FIG. 9, the position of the gripper 64D in that case is illustrated as the position of a gripper 64D-1. At the time, a paper P-1 whose distal end is gripped by the gripper 64D-1 is transported in the state that the paper P is warped (deformed) since the distal end travels the position higher than the guide surface 130 and the end side travels while being in sliding contact with the guide surface 130. Therefore, when the drying processing is performed by the ink drying processing part 20 in the state, the paper P is curled even after being dried, and there is a possibility that the quality as a printed matter declines.

On the other hand, in the present embodiment, by providing the grooves 132 that the claw members 122 (claw parts) of the individual grippers 64D enter, the distal end portion of the paper P gripped by the grippers 64D can be also moved at the position of the guide surface 130, and the entire paper P can be held in the flat shape and transported. Thus, the deformation such as a warp of the paper P is prevented from being generated.

Also, the paper gripping surface 123 of the claw member 122 of the gripper 64D may not accurately coincide with the height of the guide surface 130 as described above. For example, since the paper P is thin, in FIG. 10, when the height of the guide surface 130 is in the range of being equal to or higher than the height of the paper gripping surface 123 of the claw member 122 and being equal to or lower than the height of the paper gripping surface 125 of the fixed claw 124, the paper P is held in a sufficiently flat shape.

Also, without being limited thereto, the position where the claw part of the gripper 64D grips the paper P and the position of the guide surface 130 may be shifted in the height direction in the range of not generating the deformation such as a warp to be a problem on the paper P (the range in which the deformation is reduced in comparison with the case without the grooves 132). The warp of the paper P can be reduced at least in the state that the claw member 122 does not interfere with the guide surface 130 by the grooves 132 and a difference in heights between the guide surface 130 and the paper gripping surface 123 of the claw member 122 becomes small in comparison with the case that the grooves 132 are not formed. Also, it is desirable that the difference is equal to or smaller than 5 mm, and it is more desirable when it is equal to or smaller than 2 mm.

It is assumed that the position in the height direction of the guide surface 130 to be the position within such a range is called the position corresponding the position where the claw part of the gripper 64D grips the paper P.

In the guide plate 72 of the first embodiment above, the individual guide surfaces 130 (130A-130E) are formed of individual members, and the individual grooves 132A-132D may be formed by gaps between these members.

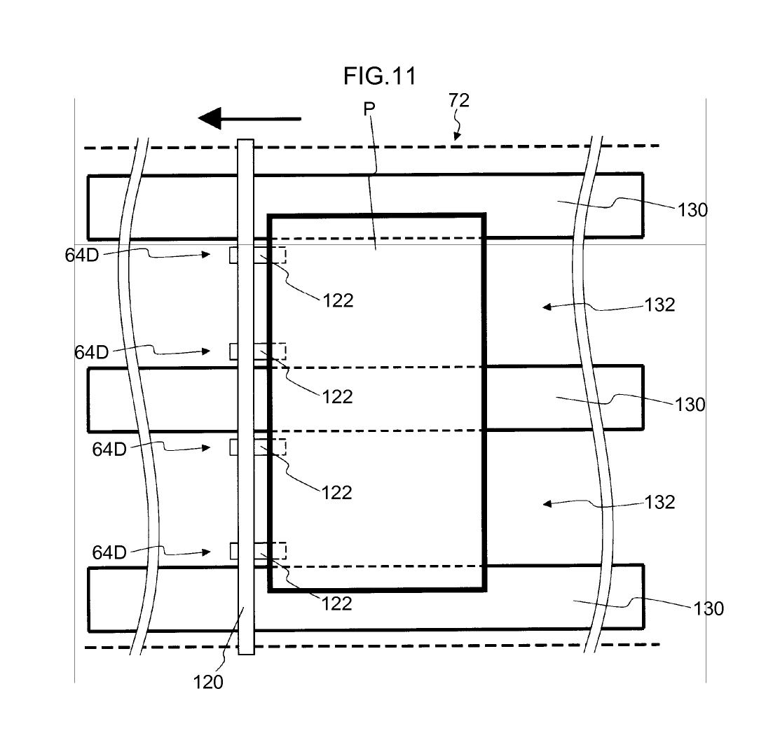

Also, as illustrated in FIG. 11, the configuration may be such that the claw members 122 of two grippers 64D enter one groove 132, or the configuration may be such that the claw members 122 of three or more grippers 64D enter one groove 132. That is, in the case that the number of the grippers 64D arranged side by side in the paper width direction is n pieces, the number of the grooves can be equal to or smaller than n (and equal to or larger than 1), and the claw parts of the plurality of grippers 64D can enter one groove.

Also, the guide plate 72 may be divided into two or more and arranged in the transporting route of the paper P transported by the chain gripper 64 as in FIG. 1.

### Guide Part in Second Embodiment

Next, the second embodiment of the guide part 66 (guide plate 72) will be described. The guide plate 72 of the guide part 66 in the second embodiment is the one for which a back tension imparting function is added to the guide plate 72 of the guide part 66 in the first embodiment, and has a function of imparting back tension to the paper P transported while the distal end is gripped by the chain gripper 64.

Since the guide plate 72 in the second embodiment coincides with the guide plate 72 in the first embodiment in the basic configuration, the same signs are attached to components of the actions same as or similar to that in the first embodiment, the description is omitted, and only changes will be described.

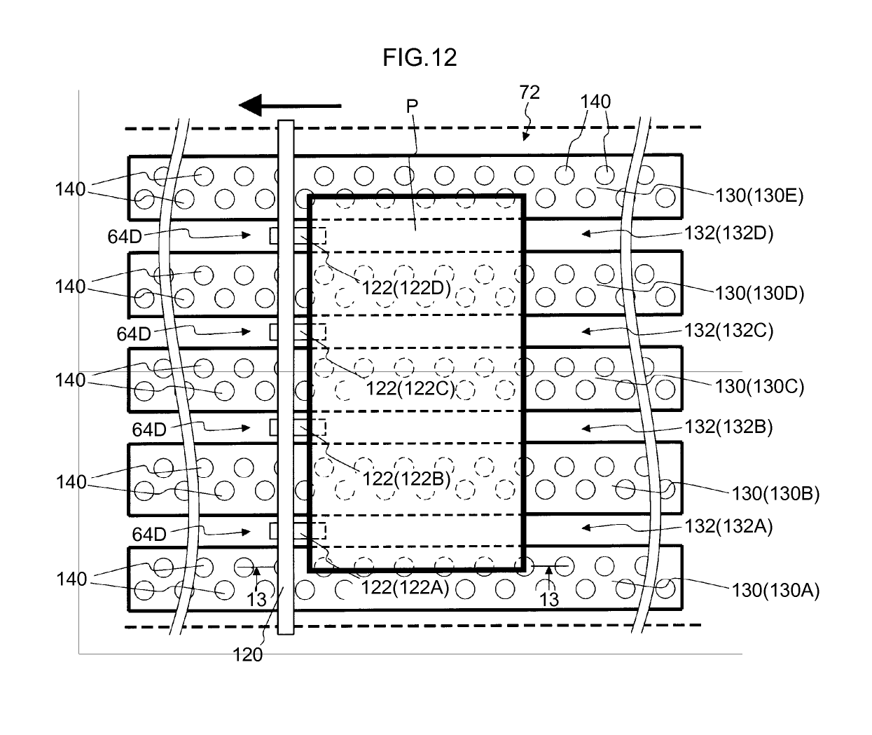

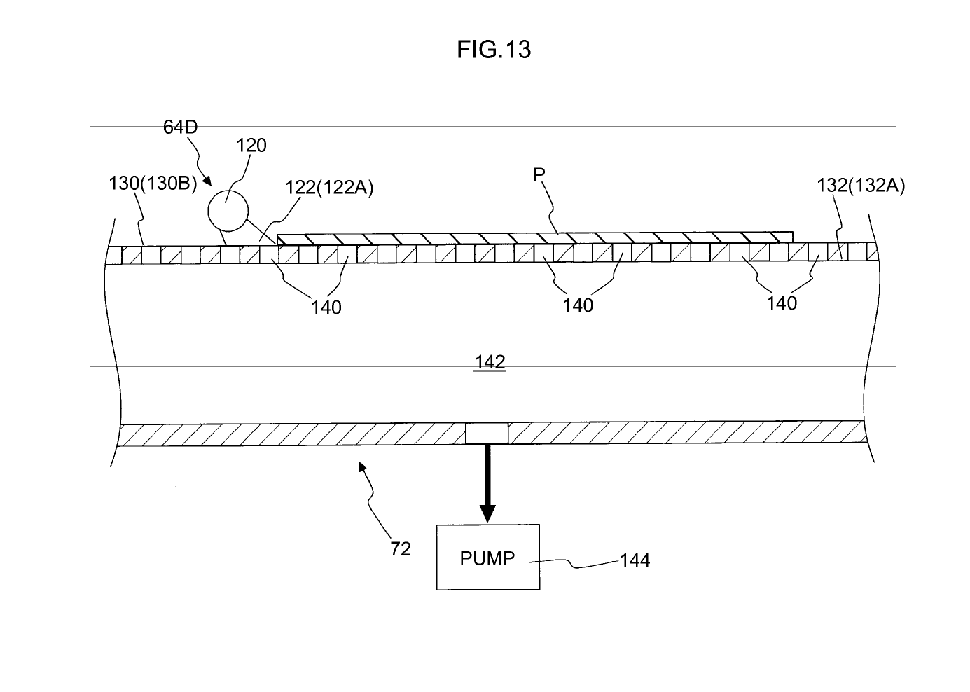

FIG. 12 is a plan view illustrating the guide plate 72 in the second embodiment, and FIG. 13 is a sectional view on arrows 13-13 in FIG. 12.

As illustrated in the figures, many adsorption holes 140 are perforated in a prescribed pattern on the guide surfaces 130 (130A-130E) of the guide plate 72, and a suction mechanism that sucks the air from the adsorption holes 140 is provided.

For example, a hollow part 142 (void) is formed inside the guide plate 72, and a pump 144 is connected through a pipeline which is not illustrated and communicated with the hollow part 142. Then, by turning the hollow part 142 to a negative pressure by the pump 144, the air is sucked from the adsorption holes 140.

Also, the similar adsorption holes may be formed on a bottom surface or a side face of the grooves 132 (132A-132D) as well.

By the guide plate 72 in the second embodiment, the air is sucked from the adsorption holes 140 of the guide plate 72, the back surface of the paper P transported by the chain gripper 64 is sucked by the adsorption holes 140, and the back tension is imparted to the paper P. Thus, the paper P is surely brought into contact with the guide surface 130 and is transported while holding the flat shape. Therefore, the warp (deformation) of the paper P is more effectively prevented. Also, when the paper P transported by the chain gripper 64 passes through the ink drying processing part 20 (see FIG. 1), since the hot air is blown to the surface of the paper P, the paper P tends to flap by the hot air, but even such flapping is surely prevented by imparting the back tension.

Also, the back tension may be imparted by arbitrary unit other than adsorption by suction.

### Guide Part in Third Embodiment

Next, the third embodiment of the guide part 66 will be described. The guide part 66 in the third embodiment illustrates a form of forming the guide surface on a belt surface of an endless belt circulated at the same speed as the transporting speed of the paper P by the chain gripper 64, which is a form using an adsorption belt as the endless belt.

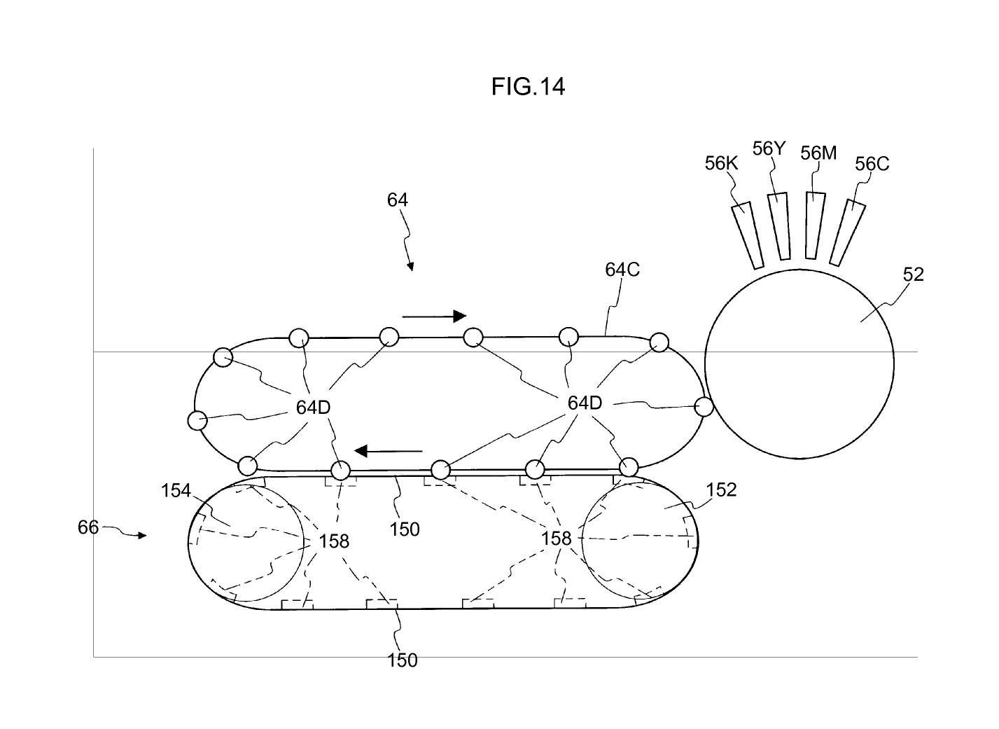

FIG. 14 is a side view illustrating the guide part 66 in the third embodiment by simplifying the paper transporting mechanism of the ink drying processing part 20, the UV irradiation processing part 22, and the paper discharge part 24, similarly to FIG. 3. The same signs are attached to the components of the same or similar actions as the components in FIG. 3, and the description is omitted.

In the figure, the guide part 66 includes an endless adsorption belt 150, a driving roller 152, and a driven roller 154.

The adsorption belt 150 is disposed to the driving roller 152 and the driven roller 154, and is circulated counterclockwise between the driving roller 152 and the driven roller 154 by turning by a motor of the driving roller 152. Then, a traveling route on the upper side is arranged along the traveling route of the long side portion on the lower side to be the paper transporting part of the traveling route of the chain 64C of the chain gripper 64.

Thus, the surface of the adsorption belt 150 is arranged as the guide surface (transporting surface) of the paper P in parallel with the paper transporting direction and the paper width direction to the arrangement side of the chain gripper 64.

Also, the adsorption belt 150 travels at the same speed as the transporting speed of the paper P transported by the chain gripper 64, and the surface of the adsorption belt 150 is mounted with the paper P transported by the chain gripper 64 and moved to the downstream side of the paper transporting direction together with the paper P while holding the paper P in the flat shape.

Further, the adsorption belt 150 is molded with a resin material for example, and is capable of adsorbing the paper P transported by the chain gripper 64 to the belt surface (guide surface) by imparting electric charges to the belt surface. Thus, similarly to the second embodiment, the flapping of the paper P due to the hot air when passing through the ink drying processing part 20 (see FIG. 1) is prevented. However, the adsorption function may not be always provided, and a belt without the adsorption function may be used instead of the adsorption belt 150.

In the configuration of the guide part 66 like this, a groove along the paper width direction is formed on the surface of the adsorption belt 150 so that the paper P gripped by the grippers 64D is held in the flat shape along the guide surface from the distal end to the end, similarly to the first and second embodiments.

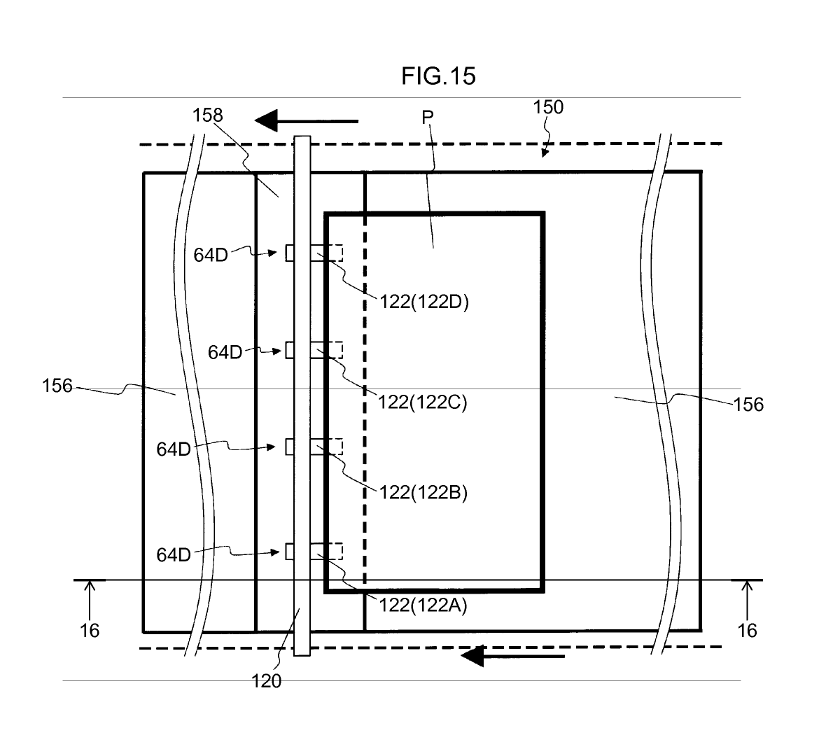

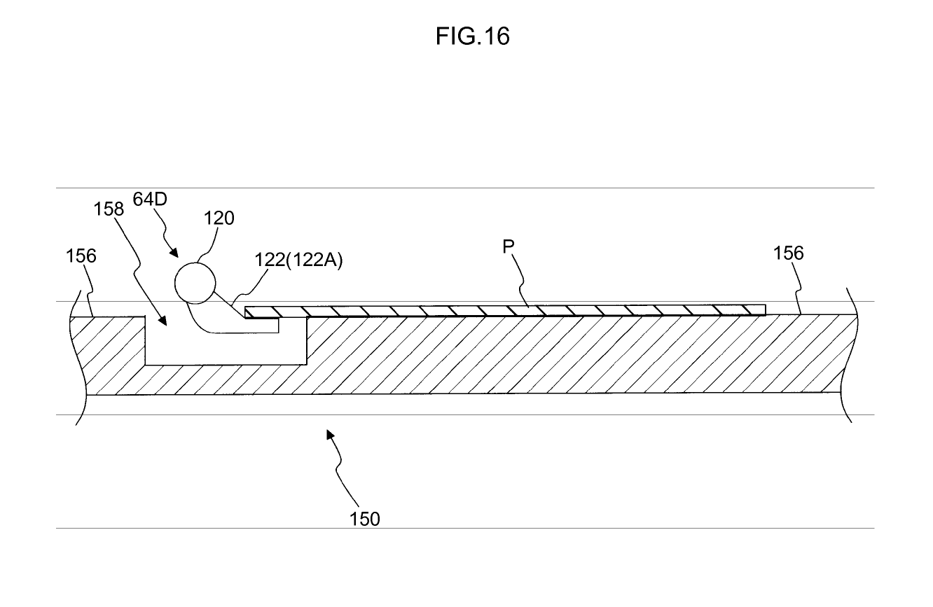

FIG. 15 is a plan view illustrating the adsorption belt 150 traveling the traveling route on the upper side from the upper surface side, and FIG. 16 is a sectional view on 16-16 thereof. Also, in these figures, the signs used in FIG. 8 or the like in the first embodiment are attached regarding the components of the chain gripper 64, and detailed description is omitted.

As illustrated in these figures, the gripper shaft 120 in the paper width direction is arranged at the upper part of the upper surface side of the adsorption belt 150, and the plurality of grippers 64D (claw members 122A-122D) are arranged at positions at fixed intervals in the paper width direction along the gripper shaft 120.

These four grippers 64D travel in the paper transporting direction when transporting the paper.

In contrast, on the upper surface of the adsorption belt 150, guide surfaces 156 and grooves 158 are alternately formed regarding the paper transporting direction.

The guide surfaces 156 are arranged so as to be along a plane in parallel with the paper transporting direction and the paper width direction in an area arranged along the traveling route to be the paper transporting part of the chain 64C of the chain gripper 64.

On the other hand, the grooves 158 are formed along the paper width direction at position (and the periphery) opposing the claw members 122 (122A-122D) of the individual grippers 64D arranged side by side in the paper width direction, and form the recess recessed to the guide surfaces 156. Also, the width in the paper transporting direction of the grooves 158 is formed in such a size that at least the claw members 122 (122A-122D) can enter.

Also, as a positional relationship regarding the height direction between the guide surface 156 and the groove 158 of the adsorption belt 150 and the claw member 122 (122A) of the gripper 64D is illustrated in FIG. 16, a part of the lower side of the claw members 122 (122A-122D) of the individual grippers 64D is arranged so as to enter the inside of the groove 158 lower than the height of the guide surface 156.

Also, the position in the height direction of the guide surface 156 may be shifted in the height direction from the position where the claw part of the gripper 64D grips the paper P in the range of not generating the deformation such as a warp to be a problem on the paper P (the range of reducing the deformation) similarly to the description in the first embodiment, and may be the position corresponding to the position where the claw part of the gripper 64D grips the paper P. Since the relationship between the height of the guide surface 156 and the height of the claw member 122 of each gripper 64D (the height of the position of gripping the paper P) coincides with contents described in the first embodiment, the description is omitted here.

Also, since the adsorption belt 150 is traveling at the speed that coincides with the transporting speed of the paper P, the relative positional relationship between the position of the gripper shaft 120 (the claw member 122 of each gripper 64D) and the position of the groove 158 does not change.

The groove 158 like this is provided at a plurality of positions along the traveling route of the adsorption belt 150 as illustrated in FIG. 14. That is, the plurality of grooves 158 are provided so that the groove 158 of the adsorption belt 150 is arranged at the position opposing the gripper 64D when the grippers 64D at the individual positions along the traveling route of the chain 64 of the chain gripper 64 grip the distal end of the paper P and move to the position opposing the adsorption belt 150. Then, the timing of traveling start and the position are controlled such that the traveling speed of the adsorption belt 150 is made to coincide with the transporting speed of the paper P (the traveling speed of the grippers 64D) and the groove 158 is arranged at the position opposing the position of the grippers 64D.

By the guide part 66 in the third embodiment above, similarly to the first and second embodiments, the height of the distal end of the paper P gripped by the grippers 64D and the height on the end side mounted on the guide surface 156 are the roughly coincident heights, and the entire paper P from the distal end to the end is moved together with the adsorption belt 150 and transported while holding the flat shape along the guide surface 130. Therefore, the deformation such as a warp of the paper P is prevented.

Also, since the paper P is not brought into sliding contact with the guide surface, there is a merit that a transportation scratch is not generated on the paper P.

Further, since the groove along the paper transporting direction is not formed as in the first and second embodiments, the deformation (bending) of the paper P due to the groove can be also prevented.

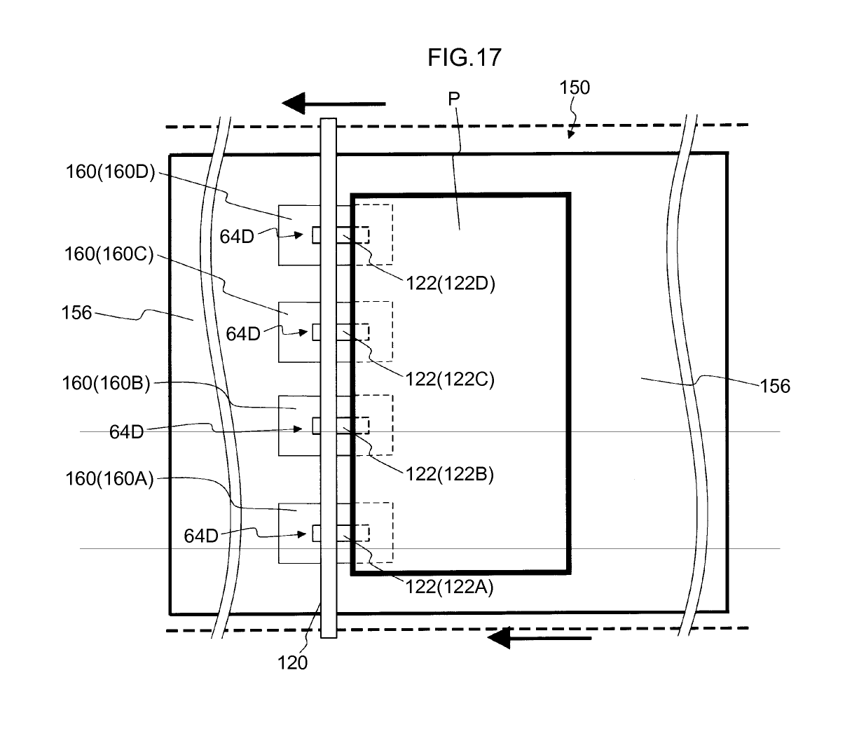

Also, in the third embodiment above, instead of the grooves 158 formed along the paper width direction, recesses corresponding to each of the claw members 122 (122A-122D) of the individual grippers 64D, that are recesses 160 (160A-160D) formed only at positions opposing the individual claw members 122 (122A-122D) of the grippers 64D as illustrated in FIG. 17, may be provided. Also, the claw members 122 of the plurality of grippers 64D may enter one recess, and in the case that the number of the grippers 64 arranged side by side in the paper width direction is defined as n, the number of the recesses provided corresponding to them can be n or smaller (and at least 1 or larger).

Also, the guide part 66 in the third embodiment may be also divided into two or more and arranged in the transporting route of the paper P transported by the chain gripper 64 as in FIG. 1.

Also, the adsorption unit that electrostatically adsorbs the paper P to the guide surface 156 in the adsorption belt 150 in the third embodiment may be applied to the first embodiment, and the adsorption unit that adsorbs the paper P to the guide surface 130 by sucking the air from the adsorption holes 140 formed on the guide surface 130 as in the second embodiment may be applied as the adsorption unit in the third embodiment.

### Others

As above, in the first to third embodiments, while the case of applying the paper transporting device according to the present invention as the paper transporting mechanism in the ink drying processing part 20, the UV irradiation processing part 22, and the paper discharge part 24 of the inkjet recorder 10 is described, the paper transporting device according to the present invention is applicable also as the paper transporting mechanism of an arbitrary part inside the inkjet recorder.

Also, without being limited to the inkjet recorder, it is applicable in an image forming device of an arbitrary system, and in that case, it is suitable to provide a drying unit that dries the paper on which the image is formed by an image forming unit in the transporting route of transporting the paper in the paper transporting device according to the present invention.

Also, in the present invention, the paper which is a target to be transported may be the one of a material other than paper, and as the paper, a sheet-like arbitrary recording medium is included.

What is claimed is:

1. A paper transporting device comprising:
a paper gripping unit configured to grip a distal end of paper turning the paper to an upstream side of a transporting direction of transporting the paper by a plurality of claw parts arranged side by side in a width direction orthogonal to the transporting direction;
a transporting unit configured to move the paper gripping unit to a downstream side of the transporting direction and transport the paper gripped by the paper gripping unit to the downstream side of the transporting direction; and
a paper guide unit including a guide surface arranged along a plane in parallel with the transporting direction and the width direction, that is the guide surface to which one surface of the paper gripped by the paper gripping unit is brought into contact,
wherein the paper guide unit has a recess recessed to the guide surface, which is the recess that a part of each of the plurality of claw parts of the paper gripping unit enters, and the guide surface is arranged at a position corresponding to a position where the claw parts grip the paper regarding a direction orthogonal to the transporting direction and the width direction.

2. The paper transporting device according to claim 1,
wherein the paper guide unit includes the guide surface formed on a fixing member, and has a groove extending along a route in the transporting direction where the claw parts are moved by the transporting unit, as the recess.

3. The paper transporting device according to claim 2,
wherein the paper guide unit has the groove corresponding to each of the plurality of claw parts.

4. The paper transporting device according to claim 1,
wherein the paper guide unit includes the guide surface formed on a belt surface of an endless belt circulated at a same speed as a transporting speed of the paper, and has a groove along the width direction that all the claw parts of the plurality of claw parts arranged side by side in the width direction enter, as the recess.

5. The paper transporting device according to claim 1,
wherein the paper guide unit is configured to form the guide surface on a belt surface of an endless belt circulated at a same speed as a transporting speed of the paper, and have recesses corresponding to each of the plurality of claw parts arranged side by side in the width direction, as the recess.

6. The paper transporting device according to claim 1,
wherein the paper guide unit includes an adsorption unit configured to adsorb the paper to the guide surface.

7. The paper transporting device according to claim 6,
wherein the adsorption unit is configured to adsorb the paper to the guide surface by sucking air from an adsorption hole formed on the guide surface.

8. The paper transporting device according to claim 6,
wherein the adsorption unit is configured to adsorb the paper to the guide surface by electrostatic adsorption.

9. The paper transporting device according to claim 1,
wherein, for the paper guide unit, the guide surface is arranged at a position that coincides with a position where the claw parts grip the paper regarding a direction orthogonal to the transporting direction and the width direction.

10. An image forming device comprising:
an image forming unit configured to form images on paper;
a drying unit configured to dry the paper where the images are formed by the image forming unit; and
the paper transporting device according to claim 1, the paper transporting device configured to transport the paper where the images are formed by the image forming unit, the paper transporting device being provided with the drying unit in a transporting route of the paper.
